(19) United States
(12) Patent Application Publication
(10) Pub. No.: US 2010/0086277 A1
(43) Pub. Date: Apr. 8, 2010

(54) SYSTEMS AND METHODS FOR DELETING VIEWED PORTIONS OF RECORDED PROGRAMS

(75) Inventor: Michael L. Craner, Chester Springs, PA (US)

Correspondence Address: ROPES & GRAY LLP, PATENT DOCKETING 39/361, 1211 AVENUE OF THE AMERICAS, NEW YORK, NY, 10036-8704, US

(73) Assignee: Guideworks, LLC, Radnor, PA (US)

(21) Appl. No.: 12/245,534

(22) Filed: Oct. 3, 2008

(51) Int. Cl. G11B 27/00

(52) U.S. Cl. 386/52

(57) ABSTRACT

Systems and methods are provided for deleting viewed portions of recorded programs. In one embodiment, a media guidance application may provide a list of recorded programs, where each recorded program in the list includes an indication of an amount of time that the recorded program has been viewed. From the list, a user may flag the viewed portions of one or more recorded programs for deletion. In some embodiments, the media guidance application may provide a delete prompt in response to a user command to pause or stop playback of a recorded program. The delete prompt may provide the user who is viewing the recorded program with the ability to choose to delete the portion of the program viewed thus far. For example, the delete prompt may prompt the user to delete a portion of the recorded program that starts at the beginning of the program and ends at substantially the position that the user stopped or paused the recorded program.

### BACKGROUND OF THE DISCLOSURE

The present invention relates generally to managing recorded programs, and more particularly to deleting viewed portions of recorded programs.

Digital video recorders (DVRs), personal video recorders (PVRs), and other local or remote storage systems are widely available. These storage systems may be used to store any suitable type of media content, such as television programs or movies. Some types of media content may have long running times and may utilize a large amount of space in the storage system. For example, a user may record a three-hour high-definition (HD) movie or documentary onto the storage system. Because of the finite amount of storage space available on the storage system, such space-consuming media content may limit the number of other programs that can be stored on the storage device. Therefore, it would be desirable to provide systems and methods for efficiently utilizing the space on a storage device.

### SUMMARY OF THE DISCLOSURE

Accordingly, systems and methods are provided for deleting a viewed portion of a recorded program from a storage device. The viewed portion may be identified and deleted by a recording control application. The recording control application may be any application that is suitable for providing recording control or other recording-based functionality for the storage device (e.g., playback of recorded programs or deletion of recorded programs). In some embodiments, the recording control application is an interactive media guidance application, such as an interactive program guide. For purposes of clarity, and not by way of limitation, the various embodiments disclosed herein will be described as being provided by an interactive media guidance application.

In some embodiments of the present invention, the interactive media guidance application may receive an instruction from a user to perform an action associated with a recorded program. The interactive media guidance application may determine that a portion of the recorded program has been viewed, and may determine the viewed portion. At least a part of the viewed portion may be flagged for deletion by the interactive media guidance application. The interactive media guidance application may then delete the flagged part of the viewed program at an appropriate time.

In one embodiment, the action instructed by the user may be to select or highlight a listing associated with the recorded program. For example, the listing may be part of a list of programs stored on the storage device. In addition to providing titles of the stored programs in the list, the interactive media guidance application may also display indications of the length of each program and the amount of each program that has been viewed by the user. In response to receiving the user request to select the listing for the recorded program, the interactive media guidance application may determine whether a portion of the selected program has been viewed and, if so, may determine the viewed portion. The interactive media guidance application may then provide a program information display screen with a description of the program, where the program information display screen includes an option to delete the viewed portion of the recorded program when such a viewed portion may be identified. In response to receiving a user selection of the delete option, the interactive media guidance application flags at least a portion of the viewed portion of the recorded program for deletion.

Optionally, the interactive media guidance application may provide an updated list of recorded programs responsive to the user selection of the option to delete the viewed portion. The updated list may include an updated listing for the recorded program that indicates that the recorded program has been shortened. For example, the interactive media guidance application may display an indication of the length of the recorded program following the deletion of the viewed portion.

In another embodiment of the present invention, the action instructed by the user may be a general preference setting for recorded programs. For example, the general preference setting may be a setting to automatically delete viewed portions of recorded programs that are of a particular type (e.g., documentary) or quality (e.g., high definition), or based on another criteria, when the storage space on the storage device drops below a predetermined level. Thus, while a program is being recorded, the interactive media guidance application may determine that the storage space has dropped below the predetermined level, and may automatically identify a recorded program with viewed portions to flag for deletion.

In still another embodiment of the present invention, the action instructed by the user may be a user request to stop or pause the recorded program while the recorded program is being played back. The interactive media guidance application may receive the user request to stop or pause playback of the recorded program at a current viewing position in the recorded program. Responsive to the user pause or stop command at the current viewing position, the interactive media guidance application may determine a portion of the recorded program that has been viewed thus far. For example, the portion may start at the beginning of the recorded program or at the point in the program that the user began watching the program, and may end at a position corresponding substantially to the current viewing position. In addition, the media guidance application may display a delete prompt, such as a delete prompt overlay overlaid onto the frame of the recorded program at the current viewing position. The delete prompt may prompt a user to delete the portion of the recorded program viewed thus far. In response to receiving a user response to the prompt, the interactive media guidance application may flag the viewed portion for deletion from the storage device.

In some embodiments, the interactive media guidance application may provide image or video information (e.g., a preview) to help the user decide whether or where to delete to in a video that has been partially viewed. For example, in one such embodiment, a video loop preview is provided to the user which depicts substantially the last N (e.g., 30) seconds of the portion of video that is suggested for deletion. In another such embodiment, a video loop preview is displayed to the user which shows the next N seconds of video that occurs after the portion that is suggested for deletion. The image or video information may be displayed, for example, in the delete prompt or may be displayed instead of a still frame of the paused or stopped video.

Typically, the interactive media guidance application stops deleting the portion of the recorded program at the point where the pause or stop command is received. In other embodiments, however, other end points for the deleted portion may be selected. For example, the interactive media guidance application may stop deleting the recorded program at a predetermined amount of time (e.g., three minutes) in the recorded program before the pause or stop point, or at the conclusion of the most recent commercial break or chapter/scene end. This provides, for example, a small amount of video which the user may rewind into upon subsequent viewing of the video from the pause point so that he can establish context for what is to come. In still other embodiments, the end point of the portion that is prompted for deletion may be selected based on fast-forward and rewind commands issued by the user while watching the recorded program. For example, the portion that is prompted for deletion may end at a point where the user began fast-forwarding the recorded program. Alternatively, if a user watched a first portion of a program and then rewound the program to point that is before the “watched to” point, the portion of the program that is prompted for deletion may end at the point the program was rewound to. In these embodiments, only a contiguous portion of the recorded program that the user has viewed at real-time speed will be deleted from the storage device responsive to a user indication to delete a viewed portion.

The interactive media guidance application may have multi-user capabilities. In some embodiments, the interactive media guidance application may maintain a user profile for each user of the interactive media guidance application. Each user profile may include a list of recorded programs associated with that user. For example, the list may include programs that were recorded automatically based on preferences stored in the user profile, programs that were manually scheduled for recording while the user was logged into the application, or programs that have been marked as a favorite by the user. The user profile may also include indications, for each of the recorded programs in the list, as to the portions in a recorded program the user has viewed. For example, the user profile may keep track of start and end times that indicate when the user started and stopped watching a recorded program, respectively.

Using the user profiles, the interactive media guidance application may selectively delete portions of recorded programs when one of the users selects to delete part or all of a recorded program. When one of the users selects to delete part or all of a recorded program associated with that user, the interactive media guidance application may not delete the recorded program if the recorded program is still associated with another user. Thus, the other user will still able to view the program, and does not need to worry about having the program deleted without his or her knowledge or express command.

In some scenarios, the other users associated with the recorded program may also have selected to delete at least a portion of the recorded program. In response to a user selecting to delete part or all of the recorded program, the interactive media guidance application may flag the portion of the recorded program for deletion that all of the users associated with the program have selected to delete. For example, if a recorded program is associated with two users, the interactive media guidance application may not flag or delete any portion of the recorded program when the first user selects to delete a viewed portion of the recorded program, because the recorded program is being maintained for the second user. If the second user then selects to delete the entire recorded program, the interactive media guidance application may flag or delete the portion viewed by the first user (since this portion was deleted by both users).

In some embodiments, when a first user indicates that a portion of a program may be deleted but the interactive media guidance application detects that the portion of the program should be maintained (in part or in full) for a second user, the interactive media guidance application may tag the portion as deleted or marked for deletion with respect to the first user. In the former case, the interactive media guidance application may make it appear to the first user as if the deletion command was executed, when in fact the content is still maintained on the hard drive for the second user. In the latter case, the portion of the program may be seen as marked for deletion by the first and/or second user but is clearly still available. In either case, at least two different numbers may be provided to the users for hard drive space available, for example, “free” and “available for recording,” the latter being typically less than or equal to the former.

Tagging and marking also refer to two ways for a media guidance application to inform a user that a part of a viewed portion has been flagged for deletion. As used herein, “flagging” a portion of a recorded program for deletion may refer to any type of indication that the recorded program might be, will be, has been, or is queued for deletion from the storage device. For example, to flag a portion of a recorded program, the media guidance application may store an indication that the portion of recorded program might be, will be, or has been deleted, or the media guidance application may queue up the portion for deletion. Flagging a portion may or may not involve visually informing a user that the portion might be, will be, has been, or is queued for deletion. If the media guidance application does inform the user, the media guidance application may use the tagging or marking methodologies described above, or any other suitable technique.

### BRIEF DESCRIPTION OF THE DRAWINGS

The above and other aspects and advantages of the invention will be apparent upon consideration of the following detailed description, taken in conjunction with the accompanying drawings, in which like reference characters refer to like parts throughout, and in which:

FIG. 1 is a simplified block diagram of an illustrative interactive media distribution system configured in accordance with an embodiment of the present invention;

FIG. 2 is an illustrative data structure for maintaining a list of recorded programs in accordance with an embodiment of the present invention;

FIGS. 3 and 4 are illustrative data structures for maintaining user profiles and associating particular recorded programs to each user in accordance with an embodiment of the present invention;

FIG. 5 is an illustrative recording list display screen showing a list of recorded programs in accordance with an embodiment of the present invention;

FIGS. 6 and 7 are illustrative media guidance information display screens that provide program descriptions for recorded programs in accordance with various embodiments of the present invention;

FIG. 8 is an illustrative recording list display screen showing the list of recorded programs from FIG. 5 after a user has selected to delete a viewed portion of one of the recorded programs in accordance with an embodiment of the present invention;

FIG. 9 is an illustrative recording list display screen for selecting viewed portions of one or more of the recorded programs in the list of FIG. 5 for deletion in accordance with an embodiment of the present invention;

FIG. 10 is a flowchart of an illustrative process for maintaining indications of portions of a recorded program that a user has viewed in accordance with an embodiment of the present invention;

FIG. 11 is a flowchart of an illustrative process for maintaining indications of portions of a recorded program that a user has viewed at substantially real-time speed in accordance with an embodiment of the present invention;

FIG. 12 is a flowchart of an illustrative process for flagging a viewed portion of at least one recorded program for deletion in accordance with an embodiment of the present invention;

FIGS. 13 and 14 are illustrative display screens with delete prompt overlays that are displayed in response to receiving a pause command in accordance with various embodiments of the present invention;

FIGS. 15 and 16 are illustrative display screens with delete prompt overlays that are displayed in response to receiving a stop command in accordance with various embodiments of the present invention;

FIG. 17 is an illustrative setup screen for configuring general preference settings related to the deletion of viewed portions of recorded programs in accordance with an embodiment of the present invention;

FIG. 18 is a flowchart of an illustrative process for flagging a viewed portion of a recorded program for deletion when playback of the recorded program is stopped or paused in accordance with an embodiment of the present invention;

FIGS. 19 and 20 are flowcharts of illustrative processes for determining whether to provide a delete prompt in accordance with various embodiments of the present invention;

FIGS. 21-24 are recording list display screens with personalized lists of recorded programs in accordance with an embodiment of the present invention; and

FIG. 25 is a flowchart of an illustrative process for flagging a part of a viewed portion of a recorded program for deletion, where the recorded program is associated with multiple users, in accordance with an embodiment of the present invention.

### DETAILED DESCRIPTION OF THE DISCLOSURE

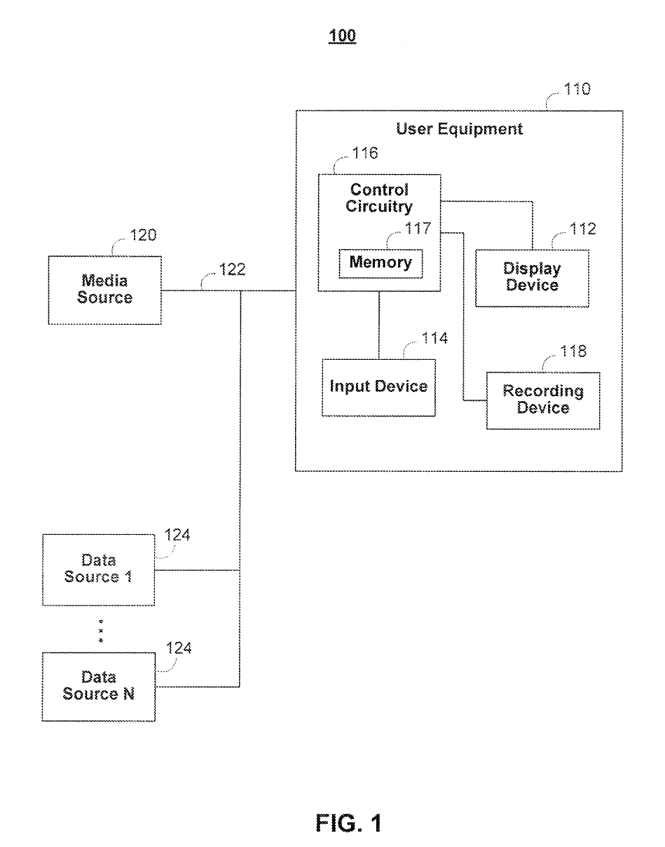

FIG. 1 shows an illustrative interactive media system 100 in accordance with one embodiment of the invention. User equipment 110 receives media in the form of signals from media source 120 over communications path 122. In practice there may be multiple media sources 120 and user equipment 110, but only one of each has been shown in FIG. 1 to avoid over-complicating the drawing.

Media source 120 may be any suitable media source such as, for example, a cable system headed, satellite media distribution facility, media broadcast facility, internet protocol television (IPTV) head end, on-demand server (e.g., VOD server), website, game service provider (e.g., for online gaming), switched digital video (SDV) system (e.g., comprising SDV manager, edge-resource manager, and edge-QAM subsystems) or any other suitable facility or system for originating or distributing media. Media source 120 may be configured to transmit signals over any suitable communications path 122 including, for example, a satellite path, a fiber-optic path, a cable path, an Internet path, or any other suitable wired or wireless path. The signals may carry any suitable media such as, for example, television programs, games, music, news, web services, video, or any other suitable media. In some embodiments, media source 120 may include control circuitry for executing requests from an interactive media guidance application implemented in, for example, user equipment 110 or a VOD server.

User equipment 110 may include any equipment suitable for providing an interactive media experience. User equipment 110 may include television equipment such as a television, set-top box, recording device, video player, user input device, or any other device suitable for providing an interactive media experience. For example, user equipment 110 may include a DCT 2000, 2500, 5100, 6208 or 6412 set-top box provided by Motorola, Inc. In some embodiments, user equipment 110 may include computer equipment, such as a personal computer with a television card (PCTV). In some embodiments, user equipment 110 may include a home theatre consumer electronic device such as, for example, a gaming system (e.g., X-Box, PlayStation, or GameCube) or a portable consumer electronic device, such as a portable DVD player, a portable gaming device, a cellular telephone, a PDA, a music player (e.g., MP3 player), or any other suitable home theatre or portable video device (e.g., an ipod Touch from Apple Inc., San Jose, Calif.).

In the example of FIG. 1, user equipment 110 includes at least control circuitry 116, display device 112, and user input device 114 which may be implemented as a separate device or as a single device. User equipment 110 may optionally include recording device 118 which may be implemented as a separate device or as a single device. An interactive media guidance application may be implemented on user equipment 110 to provide media guidance functions to the user for media displayed on display device 112. In some embodiments, the interactive media guidance application may be or include an interactive television application or any other application for providing media features to the user.

Display device 112 may be any suitable device such as, for example, a television monitor, a computer monitor, or a display incorporated in user equipment 110 (e.g., a cellular telephone or portable music player display). Display device 112 displays the media transmitted by media source 120 over path 122, or from recording device 118. Display device 112 may also be configured to provide for the output of audio.

User input device 114 may be any suitable device for interfacing with the interactive media guidance application. For example, user input device 114 may be a remote control, keyboard, mouse, touch pad, touch screen or voice recognition interface. User input device 114 may communicate with user equipment 110 and control circuitry 116 using any suitable communications link. For example, user input device 114 may use an infra-red (IR), radio-frequency, Bluetooth, wireless (e.g., 802.11), wired, or any other suitable communications link. The information received by user input device 114 may either be classified as a source selection command or a guidance application navigation command. A source selection command may include a channel change selection, video on demand selection, digital video recorder selection, or any suitable selection that causes the user to view content that is different than the content the user is currently viewing. The content the user is currently viewing may be defined as content that is currently being displayed on the display device 112. A guidance application navigation command may include any suitable command that allows the user to change the information displayed in the interactive media guidance application.

Control circuitry 116 is adapted to receive user inputs from user input device 114 and execute the instructions of the interactive media guidance application. Control circuitry 116 may include one or more tuners (e.g., analog or digital tuners), encoders and decoders (e.g., MPEG decoders), processors (e.g., Motorola 68000 family processors, or MIPS family processors), memory 117 (e.g., RAM and hard disks), communications circuitry (e.g., cable modem circuitry), input/output circuitry (e.g., graphics circuitry), connections to the various devices of user equipment 110, and any other suitable component for providing analog or digital media programming, program recording, and interactive media guidance features. In some embodiments, control circuitry 116 may be included as part of one of the devices of user equipment 110 such as, for example, part of display device 112 or any other device (e.g., a set-top box, television and video player). Control circuitry 116 may include memory such as random-access memory for use when executing applications. Nonvolatile memory may also be used to store a boot-up routine or other instructions. In other embodiments, interactive media guidance application instructions may be executed in other suitable stand alone hardware.

Recording device 118 may be a personal video recorder (PVR), digital video recorder (DVR), video cassette recorder (VCR), DVD-recorder, compact disc recorder, or any other suitable recording device or storage device. In some embodiments, recording device 118 may be a storage device for storing or recording content or data recorded or provided by other components of interactive media system 100.

A hard disk and other storage in recording device 118 may be used to support databases. For example, recording device 118 may support a database of media guidance information for recorded programs. The media guidance information may include the title of each recorded program, the length of each recorded program, and amount of each recorded program that has been viewed by the user. A hard disk or other storage in recording device 118 may also be used to record media such as television programs or video-on-demand content or other content provided to recording device 118.

In some embodiments, recording device 118 may include IR communications circuitry or other suitable communications circuitry for communicating with a remote control (e.g., with user input device 114). Recording device 118 may also include dedicated buttons and a front-panel display. The front-panel display may, for example, be used to display the current channel to which the recording device is tuned.

In some embodiments, recording device 118 may be a network recording device (e.g., part of a network DVR system) that is located outside of user equipment 110. In some embodiments, the network recording device may be incorporated in media source 120 (e.g., at the head-end of a cable plant), data source 124, user equipment 110 (e.g., as a second recording device, or a hard drive on a home computer), an Internet server (not shown), or any other suitable device. In some embodiments, the network recording device may be a stand alone device (e.g., a commercial network recording device, or a DVR device in a home or neighborhood network). The network recording device may receive instructions to perform recordings from the interactive media guidance application implemented on any of a plurality of instances of user equipment 110.

In some embodiments, the interactive media guidance application may provide features to the user with a client/server approach. There may be one server for each instance of user equipment 110, one for multiple instances of user equipment 110, or a single server may serve as a proxy for each instance of user equipment 110.

User equipment 110 may receive interactive media guidance application data from one or more data sources 124. Data sources 124 may provide data for a particular type of media or for a particular application. For example, one data source 124 may provide data for non-on-demand media (e.g., non-pay and pay-per-view programs), and another may provide data for on-demand media (e.g., VOD programs). Or, for example, a single data source may provide both of these types of data. For example, one data source 124 may provide data for an interactive media guidance application. Another data source 124 may, for example, provide data for another interactive application (e.g., a home shopping application, and real-time data such as sports scores, stock quotes, news data and weather data). In some embodiments, data sources 124 may provide data to the interactive media guidance application using a client/server approach. There may be one server per data source, one for all sources or, in some embodiments, a single server may communicate as a proxy between user equipment 110 and various data sources 124. In such embodiments, data source 124 may include control circuitry for executing the instructions of the online media guidance application. Data source 124 may provide guide data to the interactive media guidance application. In one embodiment, the guide data provided by data source 124 may be periodically downloaded in part (e.g., updated) or in whole to memory 117 of control circuitry 116. The guide data may include program listings, or any other suitable guide data.

FIG. 1 shows media source 120 and data sources 124 as separate elements. In practice, their functionality may be combined and provided from a single system at a single facility, or multiple systems at multiple facilities. For example, one media source 120 and data source 124 may be combined to provide VOD content and associated VOD data.

Any suitable number of user equipment, such as user equipment 110, may be connected to media source 120 and data sources 124, although only one instance of user equipment is shown in FIG. 1 to prevent from overcomplicating the figure. The one or more user equipment, including user equipment 110, may be connected to media source 120 and data sources 124 using a cable television network, a satellite television network, a local area network (LAN), a wireless network, the Internet (e.g., using a DOCSIS modem), or any other suitable means. In some embodiments, the equipment of the plurality of users may be connected to each other using any suitable means.

Each instance of user equipment 110 may be associated with one user or with a plurality of users. For example, user equipment 110 may be a personal device (e.g., cellular telephone) that is typically operated by a single user, or may be shared media equipment (e.g., a television system) that is typically operated by multiple users (e.g., a family). In some scenarios, a user may have multiple instances of user equipment, such as multiple instances of user equipment 110.

Although the embodiments described below may refer to recording in broadcast digital or analog television systems, it is to be clearly understood that the systems and methods of the invention may be used with any suitable video or audio content (e.g., on-demand or recorded content, and audio books) in any suitable media system (e.g., radio-frequency broadcast, cable, satellite, on-demand, and IPTV system).

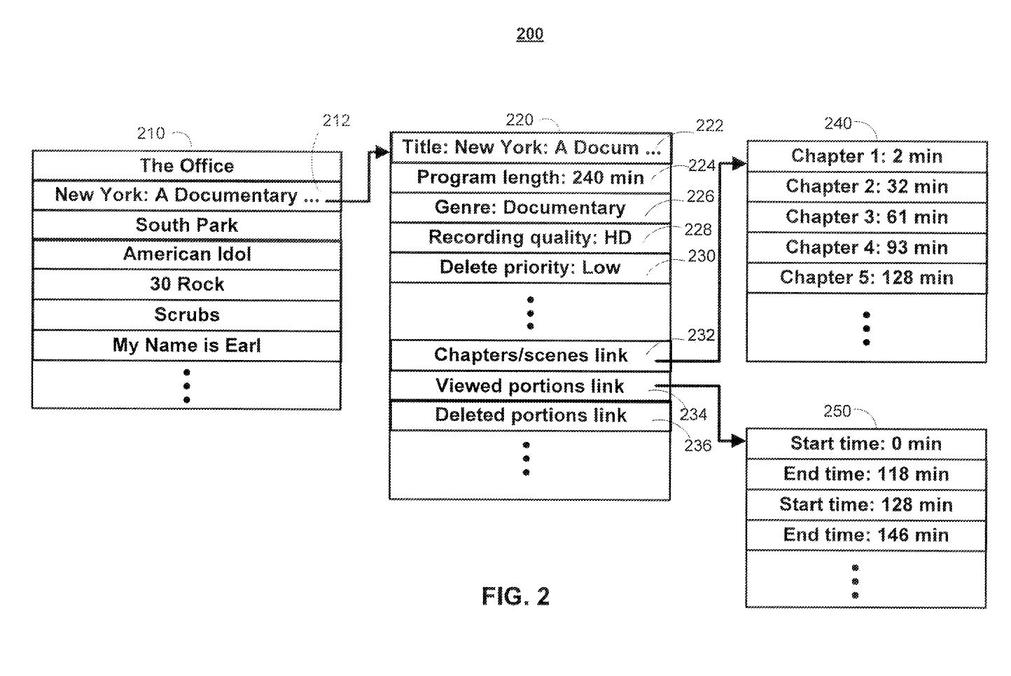

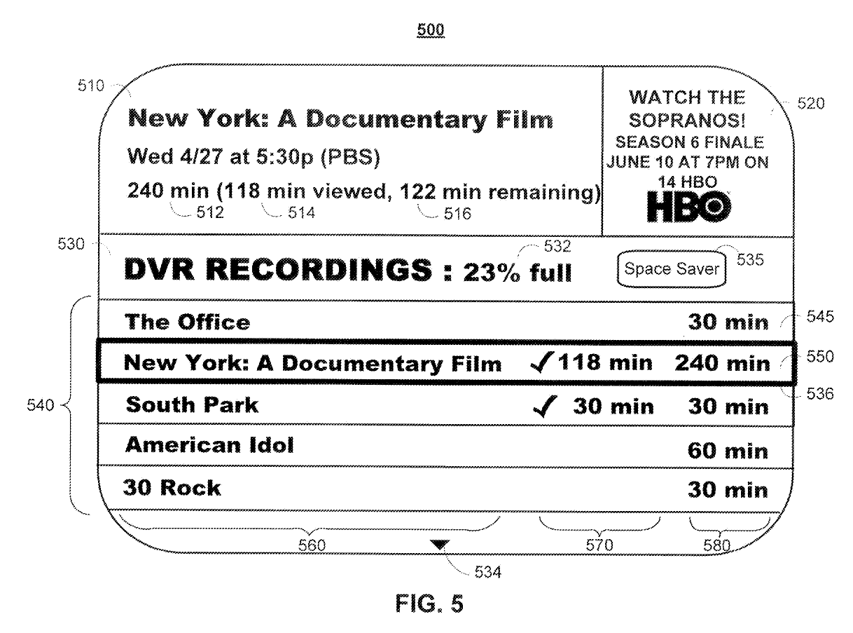

FIG. 2 shows an illustrative data structure for organizing and storing media guidance information for programs stored on recording device 118 (FIG. 1). In particular, the interactive media guidance application may maintain the media guidance information in a database in memory 117 (FIG. 1) or on recording device 118 using the format of data structure 200. The interactive media guidance application may retrieve the media guidance information from the database to provide guidance functionality (and the deletion feature described herein) for recorded programs to the user, such as to provide the display screens shown in FIGS. 5-9 and 13-17 (described below). Data structure 200 includes recorded programs list 210 indicating some or all of the programs stored in recording device 118 (FIG. 1). For example, recorded programs list 210 may include listing 212 for a recorded program titled “New York: A Documentary Film.”

Each listing in recorded programs list 210 may include a link to additional media information about the program associated with that listing. Listing 212 for “New York: A Documentary Film,” for example, may store an address to the memory location in recording device 118 where program information structure 220 is maintained. Program information structure 220 may provide any of a variety of information about the associated recorded program, such as title 222, program length 224, genre 226, recording quality 228, and delete priority 230, as well as any other suitable information about the recorded program. Program information structure 220 may also include links to other lists or structures that provide further information about the associated program. For example, program information structure 220 may include chapters/scenes link 232, which may pointsto chapters/scenes list 240. Chapters/scenes list 240 may include indications of positions in the recorded program where scene or chapter changes occur in the recorded program (e.g., the amount of time into the recorded program of a chapter/scene change or a memory location within recording device 118 (FIG. 1) where a chapter/scene starts). The location of scene or chapter changes may be received from data sources 124 (FIG. 1) and/or may be selected by the user. For television programs, chapters/scenes list 240 may include indications of the beginning and/or end of commercial breaks.

In some embodiments, program information structure 220 may include viewed portions link 234. Viewed portions link 234 includes a pointer or index to the memory location of viewed portions structure 250. Viewed portions structure 250 may include one or more pairs of start times and end times. A start time may refer to a time (e.g., in minutes) into the recorded program, a memory location in recording device 118, or any other representation of a point in the recorded program where the user started to watch the recorded program. An end time may refer to a time (e.g., in minutes) into the recorded program, a memory location in recording device 118, or any other representation of a point in the recorded program where the user stopped watching the recorded program. Based on the information in viewed portions structure 250, the interactive media guidance application may keep track of which portions in the recorded program that a user has already viewed. In particular, the interactive media guidance application may use the start times and end times to determine the total amount of viewed time and the portions of the recorded program that have been viewed. For the illustrative start and end times provided in FIG. 1, viewed portions structure 250 indicates that a user has watched the first 118 minutes (e.g., from minute zero to minute 118) of “New York: A Documentary Film,” as well as minutes 128 through 146 of the recorded program. The time between minute 118 and minute 128 of the program may represent parts of the program that were skipped by the user (e.g., using a “NEXT CHAPTER” or “NEXT SCENE” command). In other scenarios, the time between minute 118 and minute 128 may instead represent parts of the program that were fast-forwarded through by the user, and therefore not viewed at substantially a real-time speed.

The interactive media guidance application may keep track of which portions of a recorded program have been viewed by a user using any suitable approach. For example, instead of linking to viewed portions structure 250 with start and end times, the media guidance application may store a single time or memory address in program information structure 220 corresponding to furthest overall point in the recorded program viewed by the user (e.g., minute 146 in the example of FIG. 2) or to the furthest point in the recorded program viewed by the user without any breaks in viewing (e.g., minute 118 in the example of FIG. 2). In still other embodiments, the media guidance application may store the percentage of the recorded program that has been viewed by the user.

In some embodiments, program information structure 220 includes deleted portions link 236. Deleted portions link 236 may point to a deleted portions structure similar to viewed portions structure 250, except that the deleted portions structure includes start and end times for portions of the recorded program that have been selected or flagged for deletion. In other embodiments, instead of providing deleted portions link 236, the media guidance application may store a single time or memory address in program information structure 220 corresponding to the “beginning” of the recorded program. That is, in scenarios where a user selects to delete a beginning portion (e.g., a previously viewed portion) of the recorded program, the media guidance application may keep track of the point in the recorded program where the deletion ends. The media guidance application may or may not have actually deleted the portions of the recorded program that were selected or flagged for deletion from recording device 118 (e.g., the deletion may be pending release of the portion by another user).

In other embodiments of the present invention, the media guidance application may delete one or more chapter/scene indications from chapters/scenes structure 240 (or from another such structure linked from program information structure 220) to indicate that one or more chapters have been selected for deletion by a user. In particular, responsive to a user request to delete a portion of a recorded program, the media guidance application may update the listings in chapters/scenes structure 240 to reflect the chapters/scenes that were selected for deletion. Thus, rather than adding media guidance information in a deleted portions structure linked from deleted portions link 236, the media guidance application can delete media guidance information from data structure 200. Responsive to a user command to delete all remaining chapters in a recorded program, the media guidance application removes the recorded program from recorded programs list 210. In various embodiments, various alternative methodologies for indicating deleted and/or viewed portions of programs may be used, including other flagging methodologies.

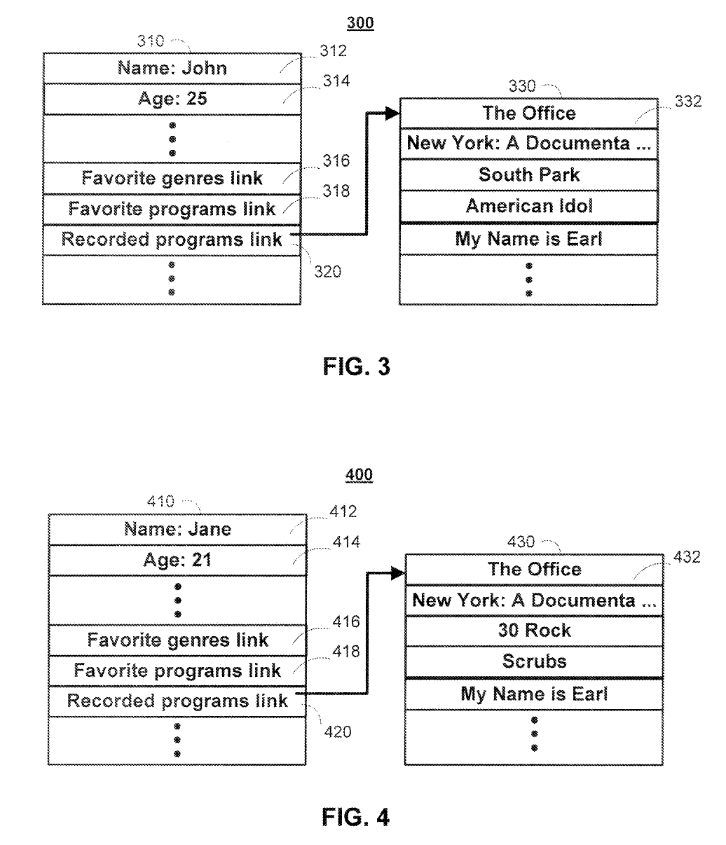

In some embodiments, the media guidance application may maintain a customized recording list for each user of the media guidance application. For example, the media guidance application may maintain a personalized list similar to list 210 of FIG. 2 for each user. Each personalized list includes programs that may be of interest to that user (e.g., programs that were scheduled for recording by the user or recorded automatically for the user). The media guidance application may maintain the personalized list of recorded programs in a user profile for that user. The media guidance application may store the user profiles in, for example, a database in recording device 118 (FIG. 1). FIGS. 3 and 4 show illustrative data structures that may be used to maintain user profiles in such a database.

User profile data structures 300 and 400 illustrate the format used to store personalized information for two users—John and Jane, respectively. User profile data structures 300 and 400 may be used to maintain any of a variety of information associated with John and Jane. For example, data structure 300 may include user information structure 310, which includes name 312 and age 314 to store the name and age of John. Data structure 400 may include user information structure 410, which includes name 412 and age 414 with information on the name and age of Jane. Structures 310 and 410 may further include links or indexes to other personalized lists associates with John and Jane, respectively. These lists include, for example, favorite genre links 316 and 416 which may point to lists indicating the favorite genres (e.g., action, horror, or science fiction) of each user, favorite program links 318 and 418 which may point to lists indicating each user's favorite television show, television series, movies, or any other type of program content, and recorded programs links 320 and 420 which point to recorded programs lists 330 and 430, respectively.

Recorded programs lists 330 and 430 may each be a list of recorded programs that their respective users are interested in. For example, the programs listed in list 330 may be the programs that were expressly or automatically recorded for John, and the programs listed in list 430 may be the programs that were expressly or automatically recorded for Jane. Thus, the media guidance application uses recorded programs lists 330 and 430 to associate different recorded programs with different users. In this example, since both users may have selected to record the same program or both users may have similar interests that caused the media guidance application to automatically record the same program for both users, the same program may appear in both lists 330 and 430 (e.g., “The Office” and “New York: A Documentary Film”).

Recorded programs lists 330 and 430 may have similar features as list 210 (FIG. 2). In particular, each listing in lists 330 and 430 may include a pointer or index to more information about the associated program. Some of the information stored in these lists may be specific to the user. For example, even though both John and Jane are associated with “The Office,” their respective program information structures for “The Office” may have different delete priorities (e.g., settings to never delete automatically, a length of time that each recorded program should be maintained, and a delete priority for each recorded program relative to other recorded programs) to indicate the importance of “The Office” to each user. Their respective chapters/scenes list may indicate different locations that were marked by each user, which in some scenarios may represent each user's favorite parts of the program. Their respective viewed portions structures may list different start and stop times that show which portions of the recorded program that each user has viewed. Their respective deleted portions structures may list different start and stop times that show which portions of the recorded program each user has selected to delete. Any other suitable information provided in connection with each user's recorded programs list may also be specific to each user, and any of the user-specific information may be customized to the user based on information directly selected by the user or automatically generated by the media guidance application using information about the user.

The media guidance application may maintain any other suitable information in addition to or instead of those shown in FIGS. 3 and 4. For example, data structures 310 and 410 may include information or links to other demographic information (e.g., gender, income level) of John and Jane, other user preference information (e.g., user-specific ratings information), and customized guidance application settings (e.g., customized background color, voice profiles for a voice recognition system). The media guidance application may use the information in each user profile to add recordings that may be of interest to a user to each user's recorded programs list, as described above.

In some embodiments of the present invention, the media guidance application may provide a user with the ability to select to delete the viewed portions of one or more recorded programs. The media guidance application may provide a user with the ability to select one or more recorded programs and delete the portions of the one or more programs that the user has already viewed. This interface may advantageously allow a user to remove portions of recorded programs that the user no longer needs, thereby freeing space on recording device 118 (FIG. 1) for new programs that the user is interested in recording. For example, a user may have recorded a documentary program that the user only wants to watch once. The documentary program may be long (e.g., 90, 120, 180, or 240 minutes). Therefore, the documentary may take up a large amount of storage space on a user's DVR or other storage device, and the user may want to view the documentary in multiple sittings. Accordingly, embodiments of the present invention allow a user to easily and conveniently delete the portions of the documentary program that have already been viewed.

FIG. 5 shows a recording list display screen 500 illustrating one embodiment of a user interface that enables a user to select to delete viewed portions of recorded programs from recording device 118 (FIG. 1). Recording list display screen 500 may include program information region 510, advertisement 520, display screen information region 530, and list 540. Display screen information region 530 indicates that the recorded programs of list 540 are from a DVR-based storage system. Although recording list display screen 500 illustrates an embodiment in which recording device 118 includes a digital video recorder, a display screen with the same or similar features may be provided for embodiments where recording device 118 includes another type of local or remote storage system (e.g., a remote server, a personal video recorder, a music player).

The interactive media guidance application may display system storage usage statistics in information region 530, such as storage space indicator 532. Storage space indicator 532 may show the amount of storage space that has been used by the recorded programs currently stored on recording device 118 (FIG. 1). For the example of FIG. 5, storage space indicator 532 shows that 23% of the storage space available for storing programs is full. Storage space indicator 532 may take any other form to indicate the amount of storage space in recording device 118 that is currently used. For example, in other embodiments, storage space indicator 532 may display the percentage of space still available or a ratio of the amount of storage space that is free or full (e.g., in megabytes) versus the amount of total storage space available. In some embodiments, particularly multiple-user embodiments, storage space indicator 532 may display at least two values, corresponding to total free space and available free space, the latter reflecting the amount of free space that is presently available and the former reflecting the amount of free space that will be available when all pending deletion requests (e.g., flagged portions of recorded programs) are processed.

FIG. 5 shows list 540 with listings for at least a subset of the recorded programs stored on recording device 118 (FIG. 1). The media guidance application may generate list 540 by accessing and processing media guidance information stored in a database on recording device 118 using data structure 200 of FIG. 2, for example. List 540 is shown in FIG. 5 as having five listings for five different recorded programs (e.g., the first five recorded programs shown in recorded programs list 210 of FIG. 2). However, this is merely illustrative, and the interactive media guidance application may display any suitable number of listings at a given time. When more recorded programs are included in recording device 118 than space is available on recording list display screen 500, the interactive media guidance application may provide arrow 534 indicating additional listings may be viewed by scrolling the display. In response to receiving a user selection of arrow 534 (e.g., from user input device 114 of FIG. 1), the media guidance application may update the listings in list 540 to represent different recorded programs stored on recording device 118.

The media information presented in the listings of list 540 are arranged into three columns. Column 560 indicates the title of each recorded program, column 580 indicates the total length of each recorded program, and column 570 indicates the amount (in minutes) of each recorded program that has been viewed by a user. The displayed lengths (e.g., in column 570 or 580) may refer to the actual length of the program (as broadcast) or the total amount of time used to store the program. For example, for a 30-minute sitcom, the displayed length may be “30 min” or may be greater if additional content is recorded before and/or after the sitcom (e.g., for buffering purposes).

The media guidance application can determine the amount of time to display in column 570 using any suitable approach. As illustrated by viewed portions structure 250 (FIG. 2), “New York: A Documentary Film” has two separate viewed portions (e.g., between minutes 0 and 128 and minutes 138 and 146). Thus, in one embodiment, the media guidance application can display the end time of the first viewed portion (e.g., 118 minutes) in column 570 of listing 550. This approach may be advantageous, because the displayed amount of time informs the user of the number of contiguous minutes of the program that the user has viewed from the beginning. In other embodiments, the media guidance application may display the end time of the last viewed portion (e.g., 146 minutes). In still other embodiments, the media guidance application may determine the total number of viewed minutes by adding the length of each viewed portion, and may display this total number of viewed minutes in column 570 (e.g., 136 minutes).

To prevent cluttering recording list display screen 500, the interactive media guidance application may display blank entries in column 570 for recorded programs that have not been viewed at all. For example, listing 545 for “The Office” may be not have been viewed for any duration by a user thus far. Therefore, listing 545 is shown in FIG. 5 as having a blank entry for column 570. In other embodiments, rather than displaying a blank entry, the interactive media guidance application may display “0 min,” “0,” “X,” or any other symbol in column 570 for listing 545 and other such listings to indicate that these listings are associated with recorded programs that do not have viewed portions.

Optionally, instead of displaying in column 570 the amount of time that has been viewed, the media guidance application may display the amount of time in a recorded program that has not been viewed. For example, in these embodiments, the media guidance application may display “122 min” in listing 550 for “New York: A Documentary Film” and “0 min” in the listing for “South Park.” This way, the media guidance application may inform the user of the amount of time remaining in the program that the user may still want to view.

Display screen 500 of FIG. 5 includes, for each listing in list 540, two entries (in minutes) to represent the amount of viewed time and the total amount of time of a recorded program. However, this is merely illustrative. The media guidance application may use any other symbol or format for representing this information. For example, the media guidance application may display the amount of time using different time units (e.g., hours), or the media guidance application may display multiple time amounts when a user has viewed multiple separate portions of the recorded program. In some embodiments, rather than displaying the amount of time in the recorded program that a user has viewed, the media guidance application may provide a viewed time bar (not illustrated) similar in appearance to a transport control bar. The viewed time bar may represent the total length of the recorded program, and may distinguish between viewed and unviewed portions using different colors, symbols, or patterns. In some scenarios, a portion of a recorded program may be deleted, and therefore the time bar may also visually distinguish deleted portions from viewed and unviewed portions (e.g., by depicting deleted portions as black or hollow). In some embodiments, the actual transport bar that is typically displayed when trick playing a program (e.g., stopping, pausing, rewinding, or fast forwarding a program) may be modified to depict the missing content if a portion of a program has been deleted. This may be depicted by showing a transport bar reflecting the entire length of the original program but distinguishing the deleted portion from the viewed but present and unviewed portions.

The listings in list 540 may be interactive. In particular, the media guidance application may be configured to receive a user selection of one or more of the listings in list 540, and may perform an action in response to receiving a user selection of one or more listings. The media guidance application may allow a user to select a listing by directly clicking on a listing or by moving highlight region 536 to a desired listing. In response to receiving a user indication to use highlight region 536 to highlight a particular listing, the media guidance application may display highlight region 536 around the particular listing and provide additional information about the corresponding program in program information region 510. For the example illustrated in FIG. 5, highlight region 536 is highlighting listing 550, and therefore information about “New York: A Documentary Film” is displayed in program information region 510. The information may include any suitable media guidance information, such as the title, original date of broadcast, original time of broadcast, the channel or station that provided the program, or any other suitable information about the recorded program (e.g., any information available from data sources 124 (FIG. 1) or any information stored in a database on recording device 118 using data structure 200 (FIG. 2)). In some embodiments, the interactive media guidance application may include a user selectable option for quickly deleting portions of one or more recorded programs. For example, in FIG. 5, “space saver” option 535 may be provided within information region 530 that when selected provides the user with options for saving space on his hard disk by deleting (or flagging) viewed portions of one, a subset, or all programs presently stored on his hard disk.

The media guidance information in program information region 510 may include program length indicator 512 to indicate the length of the actual program. Program information region 510 may also include viewed portion indicator 514 to indicate the length of the program that has been viewed by the user and remaining portion indicator 516 to indicate the length of the program that has not been viewed by the user. Therefore, in this scenario, the combined lengths displayed in viewed portion indicator 514 and remaining portion indicator 516 equals the program length of program length indicator 512. In some scenarios, program length indicator 512 and viewed portion indicator 514 may correspond to columns 580 and 570, respectively, of the currently highlighted listing. In other embodiments, program length indicator 512 and viewed portion indicator 514 may refer to the length of the program, while columns 570 and/or 580 may refer to the length of the recording stored on recording device 118 of FIG. 1 (e.g., including buffer times before and/or after the program and/or commercials). As will become apparent below, this latter approach may be advantageous, as display screen 500 would provide complete information about the actual program as originally broadcast (e.g., from program information region 510) as well as information on the length of the recorded programs (e.g., from list 540).

The media guidance application may provide advertisements in recording list display screen 500. For example, advertisement 520 is shown in FIG. 5 to be in the upper right corner of recording list display screen 500, although one or more advertisements may be provided at any other suitable location in recording list display screen 500 (e.g., as an embedded advertisement within list 540). Advertisement 520, as well as any other advertisements, may promote any of a variety of services or products, such as a future television program, an item that may be ordered online through the media guidance application, a pay-per-view program, an on-demand program, or any other suitable product or service. In some embodiments, the content of advertisement 520 may be related to the recorded program highlighted by highlight region 536 and may change as highlight region 536 is moved from one listing to another. In other embodiments, the content of advertisement 520 may be unrelated to the listing highlighted by highlight region 536, and may remain in place as long as recording list display screen 500 is displayed or may change periodically (e.g., in a rolling fashion).

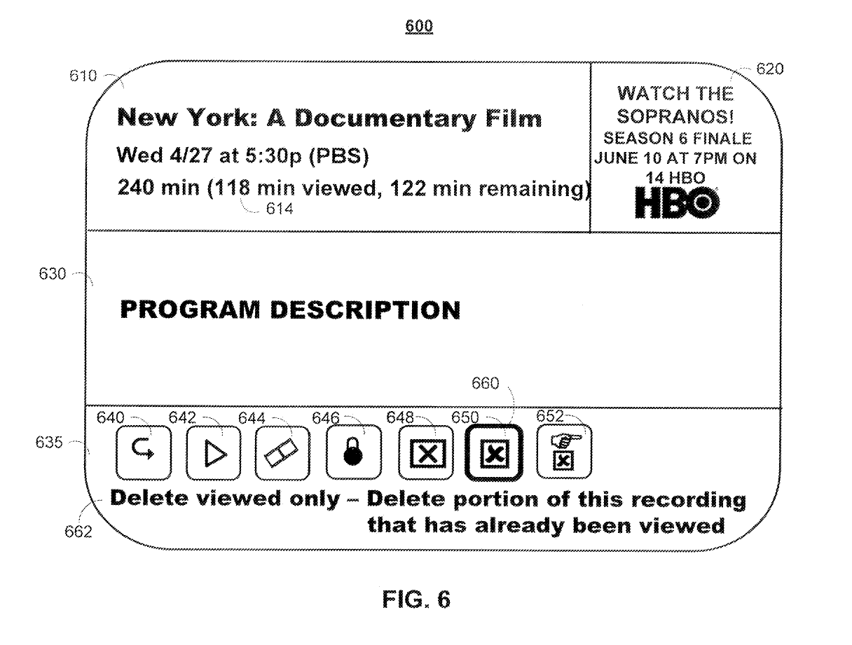

In response to receiving a user selection of a listing in list 540 (e.g., when a user selects an “OK” key when a particular listing is highlighted by highlight region 536), the media guidance application may provide a program information display screen related to the associated recorded program. An illustrative program information display screen is shown in FIG. 6, which provides information on the recorded program associated with listing 550. Program information display screen 600 may include program information region 610, advertisement 620, program description region 630, and options region 635. Program information region 610 may be similar to program information region 510 of FIG. 5, and may provide the same or a similar amount of information related to the recorded program. Program description region 630 may provide more detailed information on the recorded program. In particular, program description region 630 may provide a program description about “New York: A Documentary Film,” as well as any other available information about this program, such as the actors and/or actresses involved in the program, the date of original broadcast or the year that the program was filmed, and the MPAA rating for the program.

Program information display screen 600 includes options region 635 with options 640, 642, 644, 646, 648, 650, and 652. The media guidance application may allow a user to select one of these options by, for example, moving highlight region 660 to the desired option and selecting an appropriate button on user input device 114 (FIG. 1) or by depressing a particular button on user input device 114 that is mapped to the desired option. The media guidance application performs a different action, most of which are associated with the recorded program, in response to receiving a user selection of an option in options region 635. For example, in response to receiving a user selection of option 642, the media guidance application may begin playback of the recorded program, and in response to receiving a user selection of option 644, the media guidance application may display a preview or trailer for the program. The media guidance application may allow a user to set or change a parental control lock for the recorded program in response to receiving a selection of option 646, and the media guidance application may return to the previous display screen (e.g., recording list display screen 500 of FIG. 5) in response to receiving a user selection of option 640.

The media guidance application may provide two different delete options for deleting all or some of a recorded program, for example, delete recording option 648 and delete viewed portions option 650, respectively. The media guidance application may provide option 648 to allow a user to select to delete the entire recorded program from recording device 118 (FIG. 1). The media guidance application may provide option 650 to allow the user to select to delete just the one or more portions of the recording that have been viewed by the user. Because option 650 is highlighted using highlight region 660, information about option 650 may be displayed in explanation region 662. Thus, responsive to a user confirmation of the selected option (e.g., option 650), the media guidance application may delete the viewed portions of the recorded program.

The media guidance application may determine, for deletion, viewed portions of the recorded program in advance of or in response to receiving a user selection of the recorded program from list 540 (FIG. 5) or in response to receiving a user selection of delete viewed portions option 650. In some embodiments, the viewed portions that are determined may correspond to the portions of the recorded program indicated by viewed portion indicator 614. In particular, using the database of media guidance information (e.g., in data structure 200 of FIG. 2), the media guidance application may identify the portion of “New York: A Documentary Film” corresponding to the first 118 minutes of the recorded program. The media guidance application may then flag the identified portion from recording device 118 for deletion.

In other embodiments, the media guidance application may identify viewed portions for deletion other than the earliest viewed portion. For example, in some embodiments, the media guidance application may access the start and end times of the viewed portions from the database in recording device 118, as illustrated in FIG. 2, and may identify all of the viewed portions (and not just the earliest portion) to flag for deletion. Alternatively, the media guidance application may compare the start and end times in viewed portions structure 250 (FIG. 2) with the chapter/scene-change positions in chapters/scenes list 240 (FIG. 2), and may select parts of the viewed portions that correspond to full chapters or scenes, or content through the end of a commercial break. For example, rather than selecting the first 118 minutes of “New York: A Documentary Film” for deletion, the media guidance application may select the first 93 minutes (e.g., the first four chapters, which were fully watched) to flag for deletion.

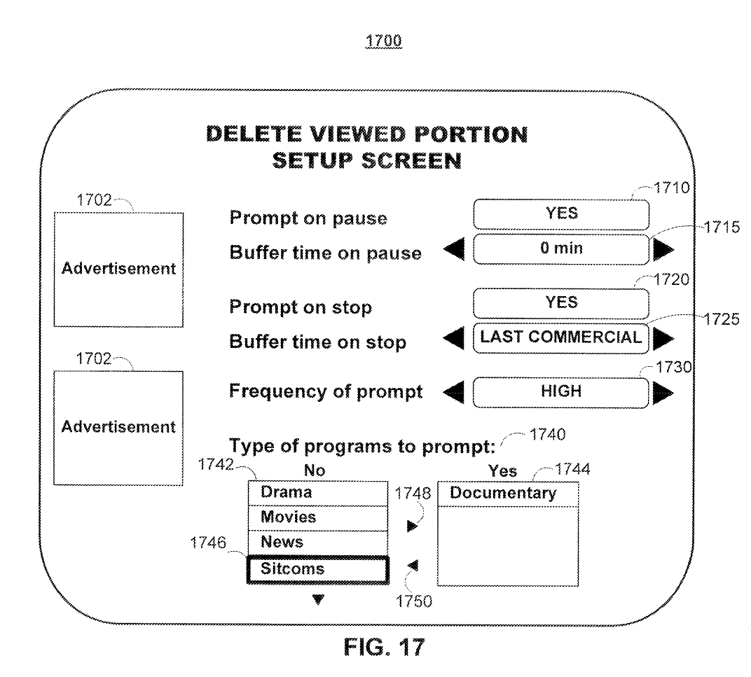

With continued reference to FIG. 6, the media guidance application may provide delete setup option 652 in display screen 600. In response to receiving a user selection of delete setup option 652, the media guidance application may display a delete setup screen. The delete setup screen may provide a user with the ability to change general preference settings related to the deletion of recorded programs, including the ability to change settings associated with deleting viewed portions of recorded programs. For example, the setup screen may provide a user with the ability to select whether to delete (or flag for deletion) all of the viewed portions or just the first viewed portion of a recorded program responsive to a user selection of delete viewed portions option 650. Other examples of settings that may be changed by a user, and an illustrative setup screen for enabling a user to change these settings, are described in greater detail below in connection with FIG. 17.

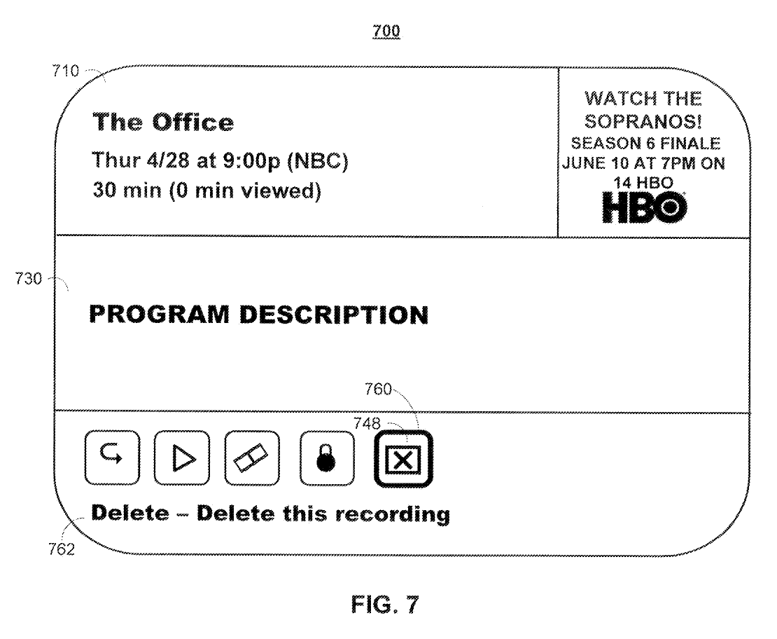

In some embodiments, the media guidance application may provide delete viewed portions option 650 only when at least a portion of the associated recorded program has been viewed. In advance of or in response to a user selection of a recorded program from list 540 (FIG. 5), the interactive media guidance application may determine whether at least a portion of the recording has been viewed by the user. The media guidance application may provide recorded program information display screen 600 when the media guidance application determines that at least a portion (e.g., 118 minutes of 240 minutes) of the recording has been viewed. The media guidance application may instead provide a display screen similar to that shown in FIG. 7, when the media guidance application determines that no portion of a recording has been viewed. Recorded program information display screen 700 may be displayed, for example, as a result of receiving a user selection of listing 545 in FIG. 5. Since “The Office” has not been viewed at all by a user, the media guidance application may provide only option 748, which allows a user to select to delete the entire recorded program. For example, as shown in FIG. 7 when option 748 is selected by highlight region 760, explanation region 762 informs the user that selecting delete option 748 will cause the recorded program to be deleted.

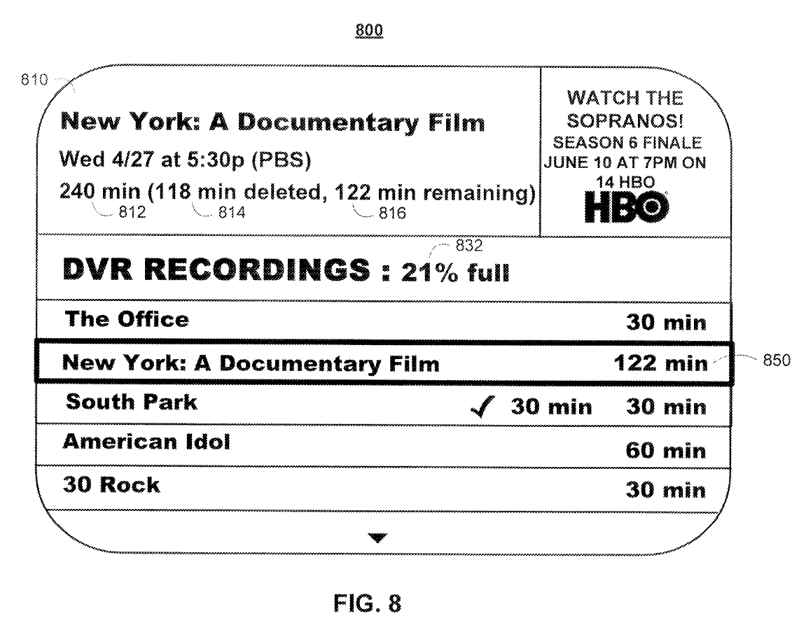

Turning now to FIG. 8, recording list display screen 800 is shown that may be provided by the interactive media guidance application. The media guidance application may present display screen 800 in response to, for example, a user input to delete the viewed portion of a recorded program (in this example, “New York: A Documentary Film”). For example, the media guidance application may display recording list display screen 800 in response to a user selection of option 650 in FIG. 6. Recording list display screen 800 may be the same as recording list display screen 500 (FIG. 5) except that storage space indicator 832 has been updated to indicate that additional storage space is available in the storage device due to the deletion of the viewed portion, and the information for “New York: A Documentary” has been updated to reflect that the viewed portion has been deleted. In particular, listing 850 shows that the recorded program has a length of 122 minutes. That is, since 118 of the original 240 minutes of the recorded program has been deleted, only 122 of the recorded program may remain on the storage device. In some embodiments, the interactive media guidance application may not have actually deleted the viewed portion, but may provide recording listing display screen 800 indicating to the viewer that the viewed portion was deleted regardless.

Program information region 810 may also be updated to reflect that the viewed portion of the recording has been deleted or was selected for deletion. To provide full information on the recording, program information region 810 may display program length indicator 812 to provide the original length of the recording (e.g., as broadcast, prior to any deletions). Program information region 810 may also include deleted portion indicator 814, which indicates the amount of the recorded program that has been deleted from recording device 118 (FIG. 1), and remaining portion indicator 816, which displays the amount of the recorded program that has yet to be viewed by the user. Thus, in this example, the user has not viewed any portion of the recorded program left on recording device 118, and therefore, remaining portion indicator 816 shows that all 122 minutes of the recording left on recording device 118 has not been viewed. In other embodiments, program information region 810 may include a viewed portion indicator (not pictured) in addition to or instead of remaining portion indicator 816. The viewed portion indicator may indicate the amount of the remaining program that has been viewed. For this example, the viewed portion indicator may be set to zero to indicate that no part of the remaining program (after deletion) has been viewed by the user.

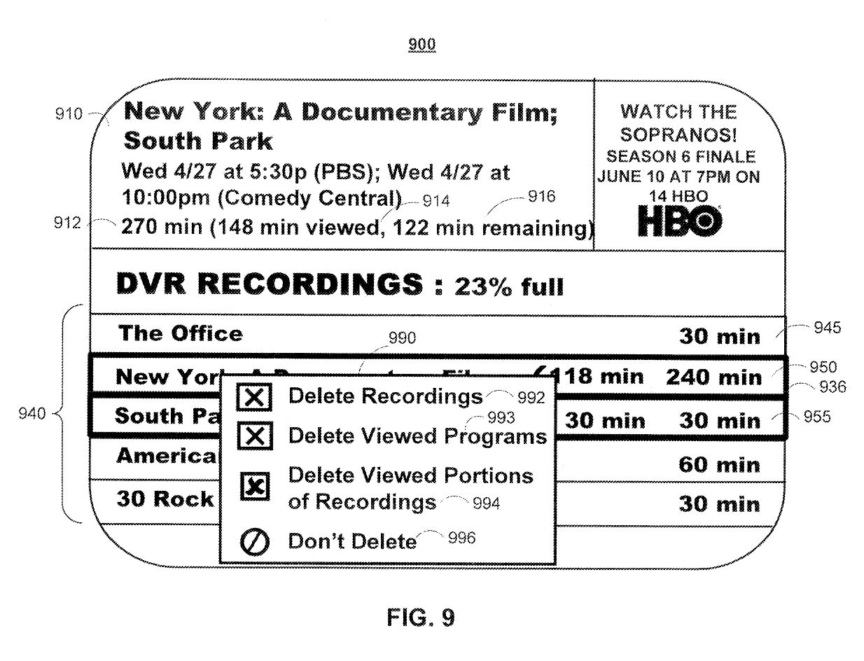

In some embodiments, the media guidance application may provide a convenient interface that allows a user to select to delete the viewed portions of multiple recorded programs at once. The media guidance application may provide a display screen, for example, similar to recording list display screen 900 of FIG. 9.

Recording list display screen 900 may include list 940, which may be the same or similar to list 540 of FIG. 5. For example list 940 may include two listings, listing 950 and listing 955, which are both associated with recorded programs that have portions that have already been viewed by a user. The media guidance application may allow a user to select multiple listings to delete in list 940 by, for example, allowing a user to directly select a plurality of listings, or by allowing a user to drag a pointer across the listings that the user wishes to select. Alternatively, the user may select space saver option 535 (FIG. 5) to invoke an operation that presents the user with a list of just those recordings that have been at least partially viewed as candidates for having those viewed portions deleted. FIG. 9 shows the result of a user selecting listing 950 and listing 955. That is, in response to a user selecting these two listings, the media guidance application may display highlight region 936 around both listing 950 and listing 960, and may update program information region 910 to include information on both associated programs. Program information region 910, in particular, may provide summary information on “New York: A Documentary Film” and “South Park.” Program length indicator 912 may indicate the combined length of the two programs, viewed portion indicator 914 may indicate the combined length of the viewed portion, and remaining portion indicator 916 may indicate the combined length that has not been viewed. Alternatively, to save space, information region 910 may contain a summary indicator such as “Multiple titles selected” in place of the titles of all the selected programs, and then provides the summary numbers (e.g., program length, viewed portion length, and/or remaining portion length) consolidated for all the selected programs. With these listings highlighted, a user may confirm the selection with the media guidance application by, for example, depressing an “OK” button or a “delete” button on a user input device 114 (FIG. 1).

In response to receiving a user confirmation of listings 950 and 955 of FIG. 9, the media guidance application may provide overlay 990. Overlay 990 may include a plurality of delete options for the selected listings. For example, overlay 990 may include delete recordings option 992, delete viewed programs option 993, and delete viewed portions of recordings option 994. Responsive to a user selection of delete recordings option 992, the media guidance application may flag the recorded programs associated with listings 950 and 955 for deletion. The amount that would be deleted by this selection is reflected by program length indicator 912.

In response to a user selection of delete viewed programs option 993, the media guidance application may delete (or flag) all programs that have been viewed in their entirety. If a user selection of option 994 is received instead, the media guidance application deletes or flags for deletion only the viewed portions of the recorded programs. In particular, the media guidance application deletes 118 minutes of recording associated with listing 950 and 30 minutes (e.g., the entire program) of the recording associated with listing 960. The total length of recordings that would be deleted from this selection is reflected by viewed portion indicator 914. If the user decides not to delete any portion of the recording, the user may select the don't delete option 996, which causes the media guidance application to remove overlay 990 without deleting any part of either “New York: A Documentary Film” or “South Park.”

The media guidance application may provide delete viewed portions option 994 in overlay 990 when the media guidance application determines that at least one of the selected programs has a viewed portion. Otherwise, the media guidance application may provide only delete recordings option 992 in overlay 990. For example, if the user selects only listing 945 for “The Office” for deletion, the media guidance application may determine that “The Office” has not been viewed by the user for any length of time, and may provide overlay 990 without an option to delete just the viewed portions. On the other hand, if the user selects listing 945 and listing 950 for deletion, the media guidance application may provide overlay 990 with an option to delete just the viewed portions. In this case, receiving a user selection of the option to delete just the viewed portions would cause the media guidance application to delete the viewed portion of the recording associated with listing 950 (e.g., “New York: A Documentary Film”), but would have no effect on the recording associated with listing 945 (e.g., “The Office”).

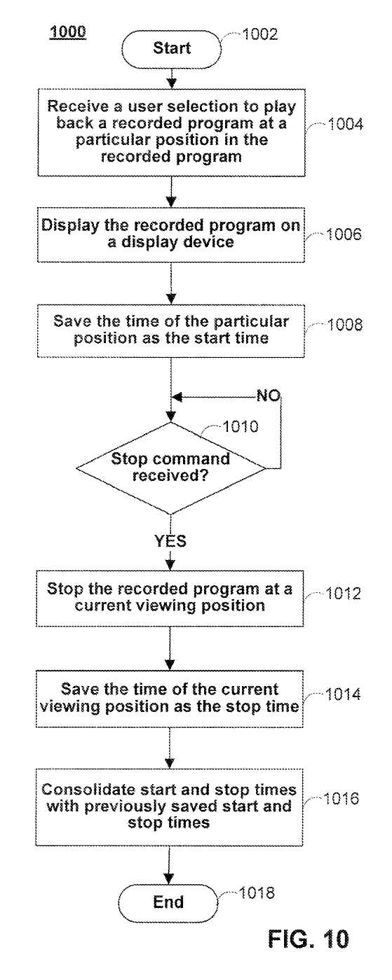

Referring now to FIGS. 10-12, flowcharts of illustrative processes are shown that may be executed by a media guidance application to update viewed portions structure 250 (FIG. 2) and to flag the viewed portions of the recordings for deletion upon user request. It should be understood that these flowcharts are merely illustrative, and the steps of the various flowcharts may be modified, combined, removed, or other steps may be added, without departing from the scope of the present invention.

Referring first to FIG. 10, a flowchart of illustrative process 1000 is shown for keeping track of which portions in a recorded program the viewer has watched. The media guidance application may use this information, for example, to provide a recording list display screen, such as recording list display screen 500 of FIG. 5, or to identify which portions of a program to delete or flag for deletion in response to a user request to delete the viewed portions of the recorded program.

Process 1000 may begin at step 1002. At step 1004, the media guidance application may receive a user selection to playback a recorded program at a particular position in the recorded program. For example, a user may select to start playback at the beginning of the program, at a particular scene in the program, or may resume the program from a previous stopping position. At step 1008, the media guidance application may save, as the “start time” of the playback, an indication of the particular position in the recorded program that playback was started at step 1006. For example, the media guidance application may keep track of the time or offset into the recorded program at which playback began or the memory location of the particular position (e.g., frame location or multiple frame data block). The media guidance application may save the start time in viewed portions structure 250 (FIG. 2), for example.

While the recorded program continues to play, process 1000 may move to step 1010, where the media guidance application determines whether a command to stop playback of the recorded program has been received from the user. If a stop command has not been received, process 1000 may stay at step 1010, and playback of the recorded program continues. If, at step 1010, the media guidance application determines that a stop command has been received, process 1000 may continue to step 1012. At step 1012, the media guidance application may stop playback of the recorded program at a current viewing position in the program (e.g., the position in the program where the stop command was received). Then, at step 1014, the media guidance application may save an indication of the current viewing position (e.g., offset time into the recorded program, or a memory address to the current viewing position) as the stop time. The media guidance application may save the stop time in viewed portions structure 250 (FIG. 2) along with the start time saved at step 1008. Thus, with both a start and a stop time saved, the media guidance application has complete information on the portion of the recorded program that the user has just viewed, and is able to determine the length of time of the viewed portion.

Process 1000 may then continue to step 1016, where the media guidance application may consolidate the start time (from step 1008) and the stop time (from step 1014) with previously saved start and stop times for the same recorded program. For example, the start and stop times that were saved at steps 1008 and 1014, respectively, may overlap or be back-to-back with the start and end times saved in previous viewings of the program. The start times may be back-to-back when a user watches a recorded program for a period time and stops at a stop time, and later chooses to resume playback of the recorded program directly or substantially from that stop time. In these types of circumstances, the media guidance application may consolidate all previous start and end times such that the viewed portions of the program may be represented with the fewest number of start and stop times possible. For the example of back-to-back portions, the first and second viewed portions may be combined such that only the start time of the first viewing and the end time of the second viewing are maintained. Once the viewed portions are consolidated, the media guidance application has current information on the viewed portions for the recorded program, and process 1000 may move to step 1018 and end.

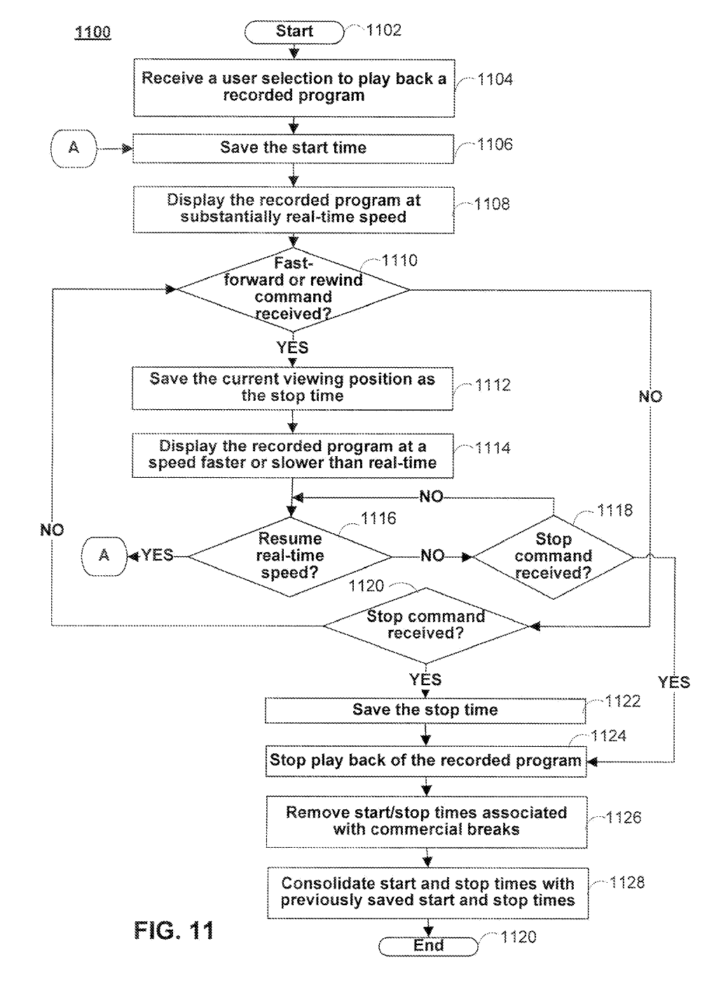

In some embodiments, the media guidance application may keep track of only the portions of a recorded program that a user views at real-time speed or substantially real-time speed. In other words, the media guidance application may not treat portions of the recorded program that were fast-forwarded through to be portions that were actually viewed by the user. Thus, in some embodiments, the media guidance application may execute the steps of process 1100 of FIG. 11, which keeps track of the start and stop times of all portions that were viewed in real-time. Real-time speed hereinafter refers to a speed of playback that is within a suitable factor (e.g., 0.9, 0.95, 1.05, or 1.1) of the intended speed of playback such that a user may still watch and understand the recorded program.

Process 1100 may begin at step 1102. At step 1104, the media guidance application may receive a user selection to playback a recorded program, and at step 1106, the media guidance application may save an indication of the starting position of playback as the start time for the recorded program. Then, also in response to receiving the user selection, the media guidance application may playback the recorded program at substantially real-time speed at step 1108. Playback of the recorded program may continue at real-time speed until a either a fast-forward or rewind command is received at step 1110 or a stop command is received at step 1120.

If, at step 1110, the media guidance application determines that a fast-forward or rewind command has been received, the media guidance application saves an indication of the current viewing position (e.g., the point in the recording where the fast-forward or rewind command was received) as a stop time for the recorded program. The media guidance application then displays the recorded program at a speed substantially faster (e.g., 20×, 40×) or slower (e.g., 0.2×, 0.4×) than real-time at step 1114 in either the forward or reverse direction, depending on the specific trick play command that was received. Playback at this faster or slower speed may continue until a command to resume real-time speed playback is received at step 1116 or a stop command is received at step 1118.

If, at step 1116, the media guidance application receives a command to resume playback of the recorded program, process 1100 may return to step 1106, where the media guidance application saves a new start time and begins displaying the recorded program at real-time speed. Thus, the recorded program may be treated as if playback began from the point that the fast-forward or rewind ended. If instead, at step 1118, the media guidance application receives a command to stop playback of the recorded program, process 1100 may jump to step 1124, discussed below, without saving an additional stop time (as one was already saved after the fast-forward or rewind command was received at step 1110).

Returning to step 1120, if the media guidance application determines that a stop command is received while the recorded program is being played back in real-time, process 1100 moves to step 1122. At step 1122, the media guidance application saves the stop time associated with the current viewing position of the recorded program where the stop command was received, and at step 1124, the media guidance application stops playback of the recorded program. Then, at step 1126, the media guidance application may remove start/stop times associated with commercial breaks in the recorded program that may have been skipped by the user during the course of viewing. That is, the media guidance application treats a portion of a recorded program to be fully watched even if a user fast-forwards through a commercial break during the portion, since the user did not miss a part of the program. Thus, at step 1126, the media guidance application may determine whether the stop and subsequent start time corresponds to a span of time that is substantially part of a commercial break. To accomplish this, the media guidance application may compare the span of time watched at a fast-forward speed with the commercial breaks saved in, for example, chapters/scenes list 240 of FIG. 2. Process 1100 of FIG. 11 may then continue to step 1128, where the media guidance application may consolidate the start and stop times that were saved with the start and stop times when the recorded program was previously played back, as described above in connection with FIG. 10. Process 1100 may then move to step 1120 and end.

In other embodiments, the media guidance application may treat fast-forward commands differently from rewind commands. For example, if a user watches a recorded program to a first point, rewinds the recorded program to a second point prior to the first point, then stops playback, the media guidance application may save the second point as the stop time rather than the first position (even though the user has viewed the recorded program at substantially real-time speed up until the first position).

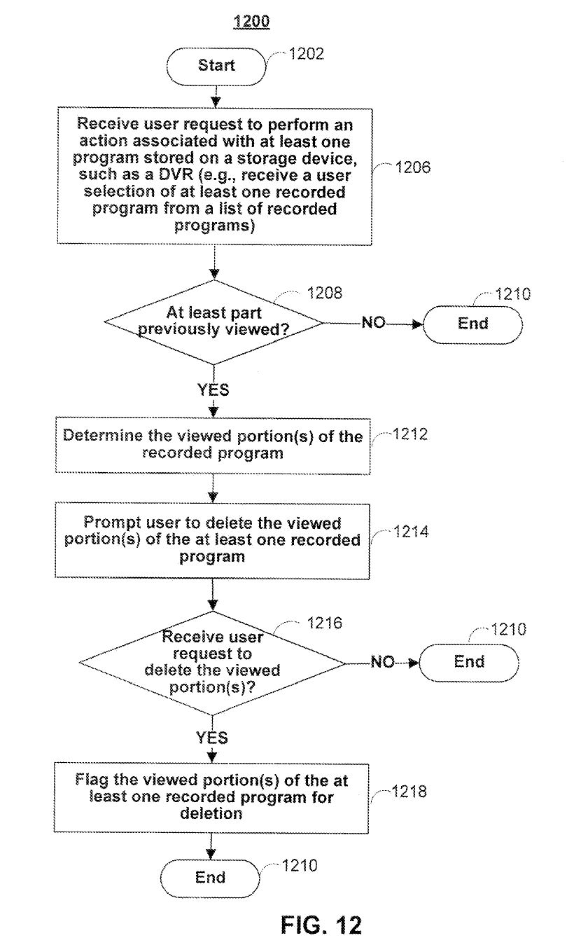

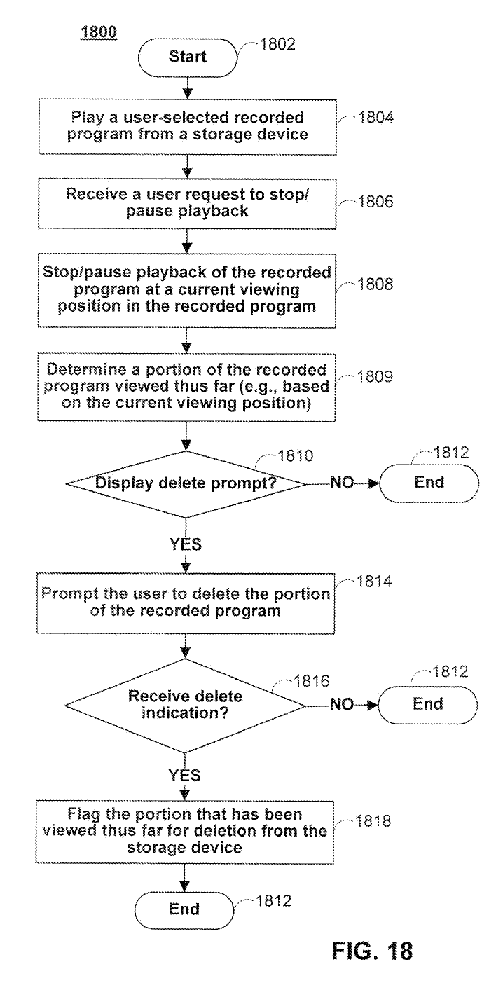

FIG. 12 is a flowchart of illustrative process 1200 for flagging viewed portions of recordings for deletion. The viewed portions may be represented by the start and stop times generated using the approaches described above in connection with FIGS. 10 and 11. Process 1200 may begin at step 1202 and proceed to step 1206. At step 1206, the media guidance application may receive a user request to perform an action associated with at least one program stored on a storage device, such as recording device 118 (FIG. 18). For example, the media guidance application may display a list of programs that are stored on recording device 118, and may then receive a user request to select at least one recorded program from the list. In response to receiving the user request to perform the action, the media guidance application may, at step 1208, determine whether at least part of the recorded program(s) were previously viewed by the user. For example, the media guidance application may access a database in recording device 118 to determine whether at least one set of start and end times have been stored for one or more of the at least one recorded program. If, at step 1208, the media guidance application determines that at least part of the recorded program has not been viewed, process 1200 moves to step 1210 and ends without deleting any portion of the at least one recorded program.

If, at step 1208, the media guidance application instead determines that at least part of the recorded program was previously viewed, process 1200 moves to step 1212. At step 1212, the media guidance application determines one or more portions of the at least one recorded program that have been viewed by the user. For example, the media guidance application may access start and end times in a database in recording device 118, and may use these times to identify one viewed portion of the recorded program, all of the viewed portions, or the scenes or chapters of the recorded program that have been viewed. Then, at step 1214, the media guidance application prompts the user to delete the one or more viewed portions of the at least one recorded program. For example, the media guidance application may display an option to delete the viewed portions in a program information display screen, such as program information display screen 600 (FIG. 6), or in an overlay on a screen, such as in overlay 990 (FIG. 9). If, at step 1216, a user request is not received responsive to the prompt, process 1200 moves to step 1210 and ends without deleting any portion of the at least one recorded program.

If, at step 1216, a user request is received to delete the one or more viewed portions of the recorded program, process 1200 continues to step 1218. At step 1218, the media guidance application may flag the one or more viewed portions for deletion from recording device 118 (FIG. 1). In some embodiments, the media guidance application may also delete the one or more viewed portions. Process 1200 may then move to step 1210 and end.

In some embodiments, a media guidance application may provide a user with the ability to select to delete viewed portions of a recorded program in response to receiving a user request to pause playback of the recorded program. In particular, when the user pauses playback of the recorded program, the media guidance application may be configured to determine a portion of the recorded program viewed thus far and prompt the user to delete the portion of the recorded program.

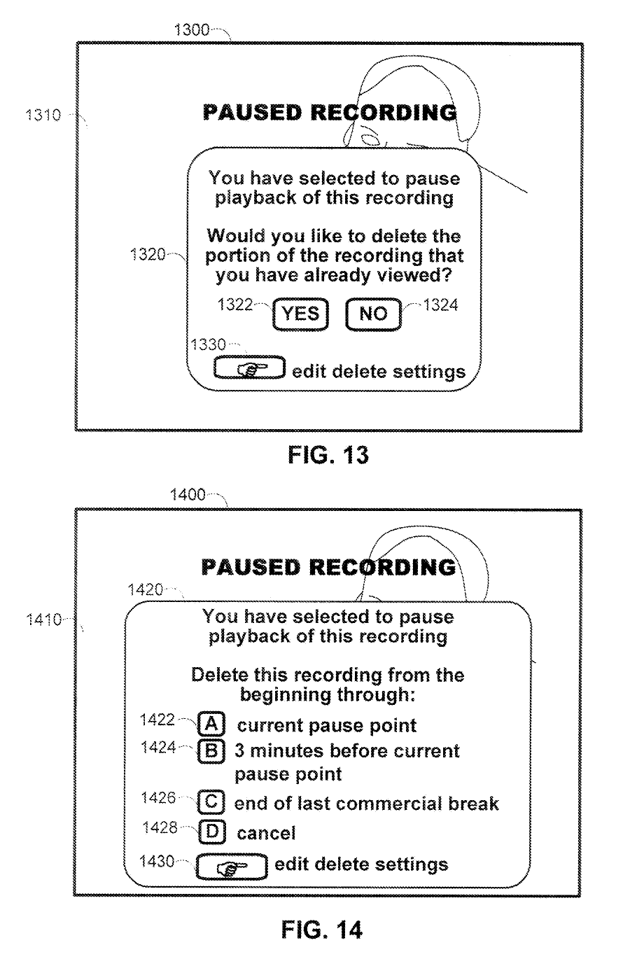

FIGS. 13 and 14 show two illustrative overlays that may be provided by the media guidance application in response to a user command to pause playback of a recorded program. Referring first to FIG. 13, display screen 1300 is shown including paused video 1310. Paused video 1310 may be a still frame of the recorded program that a user was watching at the time that a pause command (e.g., from user input device 114 of FIG. 1) is received from the user. In some embodiments, still image 1310 may be replaced by a video loop of content surrounding, starting, or ending at the point in the recorded program where the pause command is received. Also in response to receiving the pause command, the media guidance application may display delete prompt overlay 1320. Delete prompt overlay 1320 may be used by the media guidance application to provide the user with the opportunity to delete the portion of the paused recording that has already been viewed. Delete prompt overlay 1320 includes YES option 1322 and NO option 1324. In response to receiving a user selection of YES option 1322, the media guidance application may delete a portion of the recorded program or flag the portion for deletion. The portion may have a starting position at the beginning of the recorded program and an ending position substantially at the current viewing position in the recorded program.

Delete prompt overlay 1320 may include NO option 1324, which a user may select to cause the media guidance application to pause the recorded program without deleting previous portions of the recorded program. The media guidance application may instead store an end time associated with the playback of the recorded program to reflect that a portion of the recorded program has been viewed. Thus, if the user changes his or her mind about deleting the viewed portion, the viewed portion may still be deleted by the user using, for example, the display screens described above in connection with FIGS. 5-9. In response to receiving a user selection of either YES option 1322 or NO option 1324 in delete prompt overlay 1320, the media guidance application may remove delete prompt overlay 1320, leaving only paused video 1310 corresponding to the still picture of the recorded program at the current viewing position.

Another illustrative overlay that may be provided by a media guidance application in response to a user pausing playback of a recorded program is shown in FIG. 14. Similar to FIG. 13, the media guidance application may provide delete prompt overlay 1420 as an overlay over a still image of the recorded program in response to a user request to pause the recorded program. Delete prompt overlay 1420 may include a plurality of different options that provide the user with an ability to define how much of a recording to delete. Should the viewer decide not to delete any portion of the recording, the viewer may select cancel option 1428, which may cause the media guidance application to respond in a similar manner as receiving a user selection of NO option 1324 (FIG. 13). The remaining options may include current pause point option 1422. The media guidance application may delete (or flag) the recorded program from the beginning of the recorded program up until substantially the point of the pause in response to a user selection of current pause point option 1422. In this scenario, the next time a user selects to view the recorded program from the “beginning,” the recorded program may be played back starting from the current viewing position in the recorded program (e.g., from the point of the pause).

The media guidance application may provide options 1424 and 1426 to enable a user to select to delete a smaller portion of the recorded program that has already been viewed. In response to receiving a user selection of option 1424, the media guidance application may delete the portion of the recorded program viewed thus far, except for a predetermined amount of time before the point in the recording at which the pause command was received. This predetermined amount of time may be three minutes, as shown in FIG. 14, or any other suitable amount of time. Thus, option 1424 may be selected by the user when the user would like to delete the viewed portions of the recorded program, but would like to retain a small portion of the recorded program immediately preceding the point of the pause. This may be advantageous, as this approach enables the user to briefly rewind the recording when the recording is resumed, allowing the small portion to serve as a reminder of what has occurred in the recorded program thus far.

The media guidance application may delete (or flag) the viewed portion of the recorded program up until the end of the previous commercial break in response to receiving a user selection of option 1426. For example, in some embodiments, when the user selects option 1426 from delete prompt overlay 1420, the media guidance application may delete a portion of the recording corresponding to the beginning of the recorded program through the end of the most recently viewed commercial break. For movies or other programs that do not include commercial breaks, option 1426 may be replaced by an option for deleting the recording through the last chapter, scene, or logical section of the program. Providing option 1426 may be advantageous, as this deletion technique would prevent the deletion from occurring in the middle of a scene. In particular, when a user chooses to watch the recording at a later time, the beginning of the recording (after deletion) may be a logical place to start viewing the program.

Delete prompt overlay 1420 may include any other suitable options in addition to or instead of those shown in FIG. 14. For example, in one embodiment, the media guidance application may provide an option associated with a deletion technique that selects a portion of the recording to delete based on fast-forward and rewind commands received from the user. For example, in response to receiving this option, the media guidance application may delete only portions of the recording that were played at real-time speed. Thus, portions of the recording that that the user skipped using a fast-forwarding feature will not be deleted. In other embodiments, when the user views disconnected portions of the recording at real-time speed, the media guidance application may delete just the portion starting from the beginning of the recording. For example, if the user watches the first ten minutes of a recording and fast-forwards through the recording to watch a later ten minutes, the media guidance application may delete only a portion of the recorded program corresponding to the first ten minutes of the program. The media guidance application may save the start and end times of the later portions for use in deleting viewed portions of the recording at a later time, or may not save these parts of the program as having been viewed at all.

As another example of other options that may be included in delete prompt overlay 1320 (FIG. 13) or delete prompt overlay 1420 (FIG. 14), delete prompt overlays 1320 or 1420 may include a “NEVER FOR THIS RECORDING” option (not shown). This type of option may be similar to NO option 1324 of FIG. 13 or cancel option 1428 of FIG. 14, but may also be used to inform the media guidance application that the user will not want to delete a viewed portion of this recording after any subsequent pause command is received. In response to receiving a user selection of this option, the media guidance application may prevent a delete prompt overlay from being displayed after future pause or stop commands. In some embodiments, programs for which this setting has been set or not set may be stored in an “opt in” or “opt out” list that may later be editable via a preference setting menu (e.g., setup screen 1700 of FIG. 17, described below). In some embodiments, the media guidance application may also change the delete priority setting of the recorded program such that the recorded program may only be deleted responsive to a manual deletion command from the user.

Returning briefly to FIG. 13, even though the media guidance application provides only a simple YES option 1322, the media guidance application may use any suitable deletion approach in response to a user selection of this option. For example, the media guidance application may delete the entire viewed portion (e.g., up until the current viewing position), the entire viewed portion until a suitable predetermined amount of time before the current viewing position, through the most recent commercial break or chapter/scene, or based on fast-forward or rewind commands received from the user, as described above. The default deletion technique used by the media guidance application may be designated by a user through a setup screen. The setup screen may be reached using any of a variety of approaches, such as by selecting edit delete settings option 1330, by selecting a particular option in a different user interface, or through a designated button on user input device 114 (FIG. 1). The setup screen provided by the media guidance application may include any other suitable user-changeable settings related to the deletion of viewed portions of recorded programs. An example of a suitable setup screen and examples of deletion options that may be provided by such a setup screen are described below in connection with FIG. 17.

In some embodiments of the present invention, the media guidance application may prompt a user to delete viewed portions of a recorded program in response to receiving a user command to stop playback of the recorded program. The media guidance application may provide a deletion prompt in response to stop commands in addition to or instead of providing a deletion prompt in response to pause commands, as described above. In embodiments where the media guidance application provides deletion prompts in both situations, the media guidance application may provide a deletion prompt for stop commands that is the same as, similar to, or different from that provided for a pause command. For example, the deletion prompt provided when a stop command is received may include more, fewer, or the same number of deletion options, and these deletion options may or may not cause the media guidance application to perform the same actions.

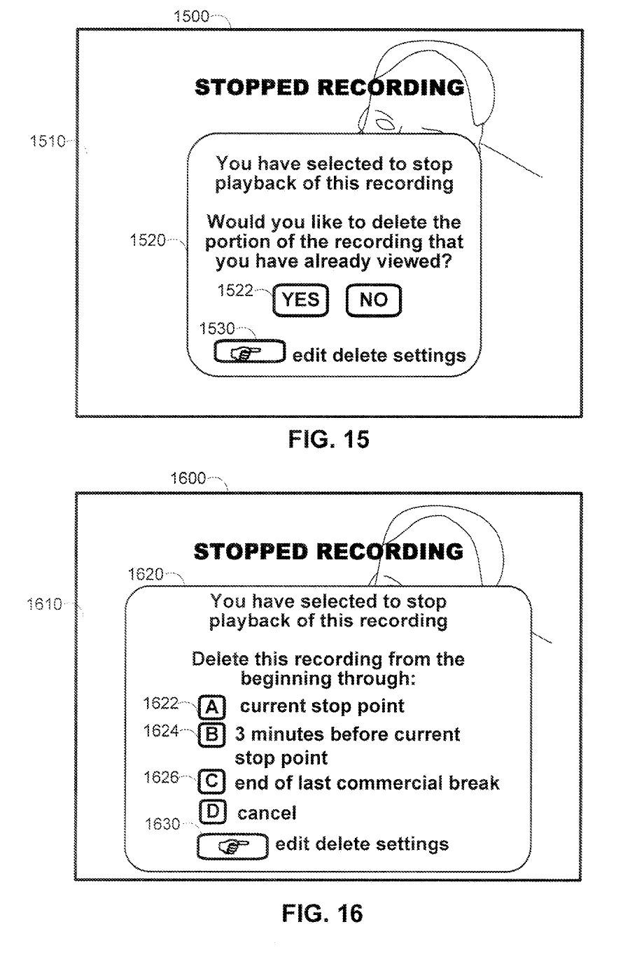

FIGS. 15 and 16 show illustrative display screen 1500 and illustrative display screen 1600 that may be displayed when a user stops playback of a recorded program. Referring first to FIG. 15, display screen 1500 includes still image 1510 of the recorded program at the point in the recorded program where the user selected to stop playback. In some embodiments, still image 1510 may be replaced by a video loop of content surrounding, starting, or ending at the point in the recorded program where the stop command is received. Display screen 1500 also includes delete prompt overlay 1520 overlaid over still image 1510. The media guidance application may display still image 1510 and delete prompt overlay 1520 in response to a user command to stop playback of the recorded program. Delete prompt overlay 1520 allows a user to delete a viewed portion of the stopped recording by selecting YES option 1522. The media guidance application may perform any of the functions described above in connection with YES option 1322 (FIG. 13) responsive to a user selection of YES option 1522.

Turning to FIG. 16, display screen 1600 includes still image 1610 of the recorded program at the point where a stop command is received and delete prompt overlay 1620. The media guidance application may provide display screen 1600 responsive to a user request to stop playback of the recorded program. Delete prompt overlay 1520 provides various options, such as options 1622, 1624, and 1626, corresponding to different deletion techniques that may be selected to delete a viewed portion of the stopped recording. The media guidance application may perform any of the actions described above in connection with options 1422, 1424, 1426, and 1428 of FIG. 14 in response to receiving a user selection of options 1622, 1624, 1626, and 1628, respectively.

The delete prompt overlays shown in FIGS. 13-16 are merely illustrative. In some embodiments, the media guidance application may provide full-screen delete prompts instead of providing delete prompts as an overlay. In some embodiments, the delete prompt overlays may include any other suitable information to allow a user to determine whether to delete the viewed portion, such as the amount of storage space that would be freed by deleting a viewed portion, the amount of time in the recorded program that would no longer be available after the deletion, the names of the scenes that would be deleted from the recorded, a video highlight of the portions in the program that would be deleted from the recorded (e.g., the first and/or last five seconds of each chapter that would be deleted), an indication as to whether the program was previously selected as a favorite, or information about any markers that may have been placed by the user in the portions of the program that would be deleted. The media guidance application may determine any of the above information by retrieving and processing the media guidance application saved within data structures 200, 300, or 400 of FIGS. 2-4, respectively. The delete prompt overlay may include any other information, such as an advertisement related or unrelated to the recorded program.

Referring again primarily to FIGS. 13 and 15, while both delete prompt overlay 1320 and delete prompt overlay 1520 may provide a YES option to allow a user to delete a viewed portion of a recording, the media guidance application may respond differently depending on whether the YES i is selected from delete prompt overlay 1320 or delete prompt overlay 1520. For example, selecting YES option 1322 from delete prompt overlay 1320 may cause the media guidance application to delete the recording from the beginning up until the current viewing position. Selecting YES option 1522 may cause the media guidance application to delete the recording from the beginning up until a predetermined amount of time (e.g., three or five minutes) before the current viewing position. This deletion technique may be advantageous, because after stopping the recording, a viewer may need to be reminded of what has already occurred in the program when the viewer is ready to resume watching the program. On the other hand, when a recording is paused, the viewer is likely to resume playback of the recording soon after issuing a pause command, and would therefore not need a refresher as to what the viewer has already watched. Accordingly, using a different deletion technique for a pause and a stop command may allow the media guidance application to delete as much of the recorded program as possible without having an adverse effect on a user's viewing experience.

In some embodiments, the media guidance application may not prompt the user to delete a viewed portion of a recorded program every time a pause or stop command is received, and may instead determine whether to prompt the user on a case-by-case basis. In particular, in response to receiving a pause or stop command, the media guidance application may determine whether to provide a delete prompt, such as one of the delete prompt overlay shown in FIGS. 13-16. The media guidance application may use any of variety of factors when making this determination. For example, the media guidance application may determine whether deleting a viewed portion would free up a significant amount of storage space in the storage device. If the media guidance application determines that a significant amount of storage space would not be gained, the media guidance application may not inconvenience the user with having to respond to a delete prompt. Other factors that the media guidance application may use to determine whether to display a delete prompt include the delete priority setting of the recorded program, the type or genre of the recorded program, the amount of time the user has been viewing the recorded program, the recording quality (e.g., high or standard definition) of the recorded program, or whether the user has previously selected a “never for this recording” option (described above) from a previous delete prompt. Further factors and processes the media guidance application may execute in order to selectively prompt a user will be described below in connection with FIGS. 18-20.

The media guidance application may provide a user with the ability to set default settings that the media guidance application uses for providing delete prompts. The settings may include settings that affect the circumstances under which the media guidance application will display a delete prompt or the number and/or type of options that are included in a delete prompt.

FIG. 17 shows an illustrative delete viewed portion setup screen 1700, which allows a user to create or update general preference settings with respect to viewed portions of recorded programs. The media guidance application may provide setup screen 1700 in response to receiving a user selection of edit delete settings options 1330, 1430, 1530, or 1630 from the delete prompt overlays of FIG. 13, 14, 15, or 16, respectively. A setup screen with one or more similar options may be displayed responsive to a user selection of option 652 from program information display screen 600 of FIG. 6 by a user. Setup screen 1700 may include a plurality of user-controllable settings, including pause prompt settings 1710 and 1715, stop prompt settings 1720 and 1725, frequency of prompt setting 1730, and “type of programs to prompt” setting 1740. In some embodiments, setup screen 1700 may include one or more advertisements 1702 that may or may not be targeted to the user or related to the program that the user was previously watching prior to accessing setup screen 1700.

Settings 1710 and 1715 of setup screen 1700 (FIG. 17) may be associated with pause commands and settings 1720 and 1725 may be associated with stop commands. In particular, settings 1710 and 1720 may be toggled to select whether the media guidance application will display a delete prompt when a pause or stop command is received, respectively. Settings 1715 and 1725 may be changed to select the deletion technique that will be used by the media guidance application when the user selects to delete a viewed portion from a delete prompt overlay.

The value of settings 1715 and 1725 may affect the operation of the media guidance application responsive to a user selection of, for example, YES option 1322 (FIG. 13) or YES option 1522 (FIG. 15) from their respective delete prompt overlays. The settings may be set to a time-based setting (e.g., “0 MIN,” as illustrative by the current value of setting 1715), which may be the amount of time before the point of a pause or stop command (or “buffer time”) that the media guidance application will retain when deleting a viewed portion. Settings 1715 and 1725 may instead specify a different type of deletion approach, such as a “LAST COMMERCIAL” setting, as shown by the current value of setting 1725, or a “NO FAST-FORWARDS” setting. The “LAST COMMERCIAL” setting may be set when the user wants the media guidance application to delete a viewed portion only through the most recent commercial break. The “NO FAST-FORWARDS” setting may be set when the user wants to delete only the first or all of the parts of a recorded program viewed at real-time speed. In some embodiments, settings 1715 and 1725 includes a “DISPLAY ALL OPTIONS” value that may be selected by the user. When this value is selected, the media guidance application may provide a delete prompt overlay similar to those of FIGS. 14 and 16 instead of a delete prompt overlay similar to those of FIGS. 13 and 15. That is, the media guidance application may allow the user to choose the deletion approach used by the media guidance application in a case-by-case basis rather than providing a simple yes and no option.

Delete viewed portion setup screen 1700 may include “frequency of prompt” setting 1730. The value of setting 1730 may be used to affect the frequency that the media guidance application prompts a user on a pause or stop command. For example, depending on the value of setting 1730, the media guidance application may change the number of factors that need to be met in order for the media guidance application to provide a delete prompt. Setting 1730 may take on a plurality of relative values of any suitable granularity, such as “LOW,” “MEDIUM,” and “HIGH” values. When a “HIGH” value is selected, the media guidance application provides a delete prompt at a high frequency. For example, the media guidance application may provide a delete prompt every time a pause or stop command is received unless the user specifically requested that delete prompts not be provided. When a “LOW” value is selected, the media guidance application provides a delete prompt at a low frequency (e.g., only when a significant amount of storage space would be gained by a deletion). In some embodiments, in addition to or instead of providing frequency of prompt setting 1730 with relative values, setup screen 1700 may allow a user to choose the particular factors that will cause the media guidance application to display a delete prompt.

With continued reference to FIG. 17, delete viewed portion setup screen 1700 may include “type of programs to prompt” setting 1740. Setting 1740 may provide a user with the ability to define which types or genres of programs that will be prompted for deletion responsive to a pause or stop command. Setting 1740 may include No list 1742 that includes types or genres that the user does not want to be prompted for deletion and Yes list 1744 that includes types or genres that the user wants to prompted for deletion. The media guidance application may display arrow 1748. In response to a user selection of arrow 1748, the media guidance application moves a listing highlighted by highlight region 1746 from No list 1742 to Yes list 1744. Similarly, the media guidance application may provide arrow 1750 that allows the user to move listings from Yes list 1744 to No list 1742. The current value of setting 1740 is one example of what a user might choose to save as the default setting. In particular, the user may only want to delete viewed portions of documentaries as the user is watching a documentary.

In some embodiments, the delete viewed portions settings may not be specific to selected programs but may be invoked when, for example, a background record causes available storage space to fall below a certain threshold. In some embodiments, the program for which viewed content deletion is suggested may not be one that is presently being watched or paused but may instead be any other program on the storage system (e.g., recording device 118 of FIG. 1) that has viewed portions. For example, during a background record that causes the available storage space to fall below a certain threshold, the media guidance application may apply any of the delete viewed portions settings in FIG. 17 and/or other settings (e.g., delete priorities) to automatically identify and delete the viewed portions of one or more programs stored on recording device 118. Alternatively, if a user is currently watching live or a recorded program, the media guidance application may provide a delete prompt similar to delete prompt 1320, 1420, 1520, or 1620, which allows the user to confirm deletion of the viewed portions of a program other than the program that the user is watching.

Referring now to FIGS. 18-20, flowcharts of illustrative processes are shown for providing a delete prompt in response to a user command to pause or stop playback of a recorded program, and for flagging viewed portions of the recording being played back for deletion. The steps shown in the flowcharts of FIGS. 18-20 may be executed by, for example, a media guidance application implemented at least partially on user equipment 110 of FIG. 1. It should be understood that these flowcharts are merely illustrative, and the steps of the various flowcharts may be modified, combined, removed, or other steps may be added, without departing from the scope of the present invention.

Referring first to FIG. 18, a flowchart of illustrative process 1800 is shown for providing a delete prompt and for deleting a portion of a recording responsive to the delete prompt. Process 1800 begins at step 1802 and proceeds to step 1804. At step 1804, a user-selected recorded program stored in a storage device (e.g., recording device 118 of FIG. 1) is played back to the user. At step 1806, the media guidance application may receive a user request to stop or pause playback of the recorded program. In response to the stop or pause command, the media guidance application may, at step 1808, stop or pause playback of the recorded program at a current viewing position. Then, at step 1809, the media guidance application may determine a portion of the recorded program viewed thus far. The media guidance application may identify an end position of the viewed portion based on the current viewing position of the recorded program using any of the techniques described above. For example, the media guidance application may determine a portion of the recorded program corresponding to the beginning of the recorded program up until the current viewing position, up until a predetermined amount of time before the current viewing position, up until the end of a most recent commercial break or scene/chapter of the recorded program, or based on fast-forward or rewind commands that were used by the user during playback of the program.

Continuing to step 1810, the media guidance application may determine whether to display a delete prompt to the user, such as a delete prompt overlay similar to those shown in FIGS. 8-11. The determination made by the media guidance application may be based on any of a variety of factors, such as properties (e.g., length, genre, quality, or size) of the portion determined at step 1809, a delete priority setting for the recorded program, or how far into the program the current viewing position is. If, at step 1810, the media guidance application determines that a delete prompt should not be displayed, process 1800 may move to step 1812 and end.

If, at step 1810, the media guidance application instead determines that a delete prompt should be displayed, process 1800 moves to step 1814. Then, at step 1814, the media guidance application prompts the user to delete the determined portion of the recorded program.

Continuing to step 1816, the media guidance application may determine whether a user indication to delete the viewed portion has been received responsive to the prompt. If such an indication has not been received, process 1800 may move to step 1812 (perhaps after a predetermined delay) and end. If, at step 1816, the media guidance application instead determines that a user indication to delete the viewed portion has been received, the media guidance application may flag the viewed portion for deletion (e.g., from recording device 118 of FIG. 1) at step 1818. In some embodiments, the media guidance application may also delete the viewed portion. Process 1800 may then move to step 1812 and end.

In some embodiments, step 1809, where the media guidance application actually determines the portion of the recorded program that may be deleted by the user, is performed at a different time than that shown in FIG. 18. For example, the media guidance application may not identify the viewed portion until after the media guidance application determines that a delete prompt should be displayed at step 1810. For embodiments in which the user can select an end position of the deleted viewed portion, such as in FIGS. 14 and 16 described above, step 1809 may instead be performed between steps 1816 and 1818. In particular, step 1816 may involve receiving a particular technique for selecting the viewed portion (e.g., based on the end of the last commercial break or based on the current viewing position). Therefore, the media guidance application may not be able to determine the viewed portion that will be deleted until after this user indication is received at step 1816. It should therefore be understood that the flowchart of FIG. 18 is merely one illustrative embodiment of the present invention.

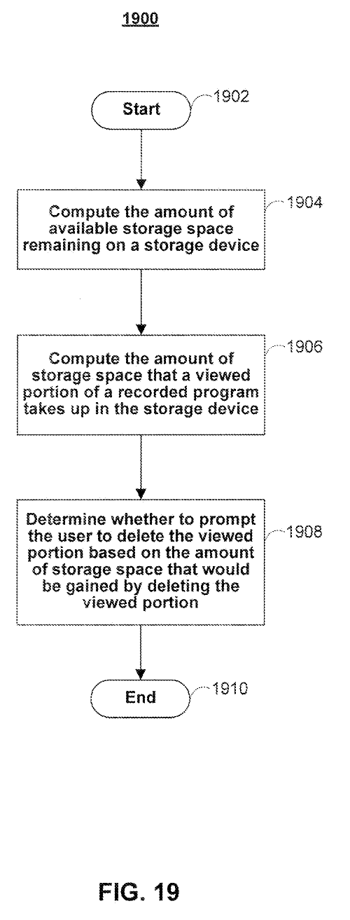

Turning to FIG. 19, a flowchart of illustrative process 1900 is shown for determining whether to prompt a user to delete a viewed portion of the recorded program in response to a user selection to pause or stop playback of the recorded program. In particular, the flowchart of FIG. 19 is one embodiment of a process for determining whether to provide a delete prompt to the user based on the amount of storage space used by the recorded program. The steps of process 1900 may or may not represent some or all of the steps taken to complete step 1810 of process 1800 (FIG. 18).

Process 1900 may begin at step 1902. At step 1904, the media guidance application may compute the amount of available storage space remaining on a storage device, such as recording device 118 of FIG. 1 (e.g., percentage of free space on the storage device or the number of megabytes/gigabytes available on the storage device). Then, at step 1906, the media guidance application may compute the amount of storage space that a viewed portion of a recorded program takes up on the storage device. The recording may be a recorded program that has been stopped or paused by the user during playback, and the viewed portion may correspond to any portion of the program from the beginning of the program up until the point where the stop or pause command was received. Like the space computed at step 1904, the media guidance application may compute the storage space taken up by the viewed portion in terms of a percentage of the storage space in the storage device or the number of megabytes/gigabytes available on the storage device, etc.

Once one or both of these storage spaces are computed, process 1900 may continue to step 1908. At step 1908, the media guidance application may determine whether to prompt the user to delete the viewed portion based on the amount of storage space that would be gained by deleting the viewed portion. For example, the media guidance application may compare the amount of available storage space on the storage space (computed at step 1904) with the amount of storage space taken up by the viewed portion (computed at step 1906) to determine whether a significant amount (e.g., megabytes or gigabytes) of the storage space would be freed by the deletion, whether a significant percentage of the used space would be freed by such a deletion, or whether a large percentage of the storage space would be available after such a deletion. Any other suitable calculation may be computed in addition to or instead of these computations to determine whether to prompt a user. After the media guidance application completes the determination, process 1900 may move to step 1910 and end.

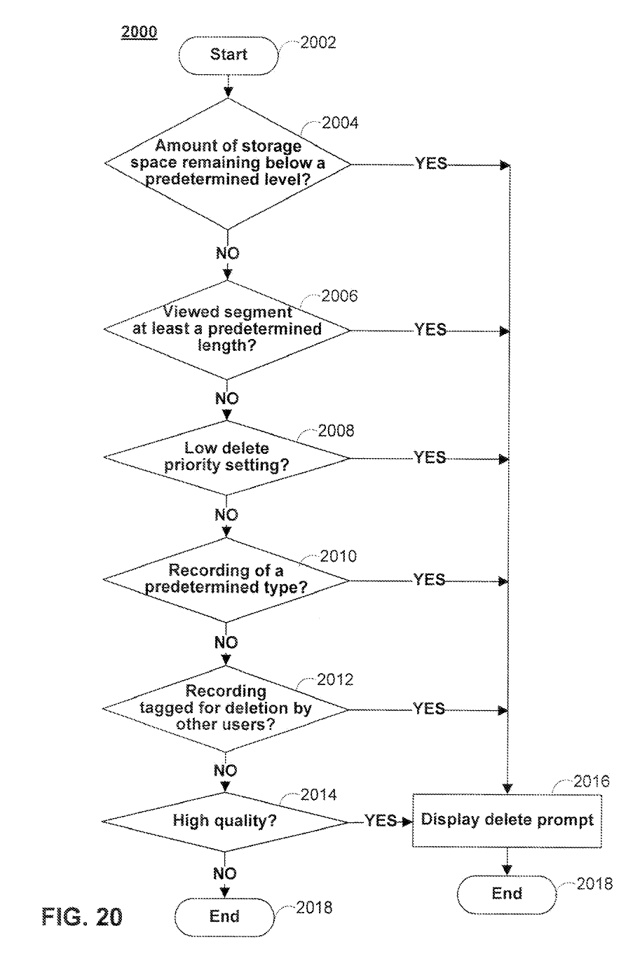

Referring now to FIG. 20, a flowchart of illustrative process 2000 is shown for determining whether to display a delete prompt responsive to a user selection to pause or stop playback of a recorded program. Process 2000, in particular, shows the steps that a media guidance application may perform to make this determination based on a plurality of different factors. The steps of process 2000 may or may not be performed as step 1810 of process 1800 (FIG. 18), and may or may not be performed instead of or in addition to the steps of process 1900 (FIG. 19).

Process 2000 may begin at step 2002. At step 2004, the media guidance application may determine whether the amount of storage space in a storage device used to store the recorded program (e.g., recording device 118 of FIG. 1) is below a predetermined level. If it is, this may indicate that the available storage space for recording future programs is low. If the media guidance application determines that the storage space is below the predetermined level, process 2000 may move to step 2016, where the media guidance application may display a delete prompt to allow a user to delete a viewed portion of the recording. Process 2000 then continues to step 2018 and ends.

If, at step 2004, the media guidance application determines that the amount of storage space is not below a predetermined level, process 2000 moves to step 2006, and the media guidance application may determine whether the viewed portion is of at least a predetermined length. For example, the media guidance application may determine whether a predetermined amount of time has elapsed in the program since the user started to watch the recording, or whether the viewed portion of the program corresponds to a predetermined amount of storage space in the storage device. If, at step 2006, the media guidance application determines that the viewed portion is at least a predetermined length, the media guidance application may display a delete prompt at step 2016 for deleting the viewed portion. Process 2000 then moves to step 2018 and ends.

Returning to step 2006, if the media guidance application instead determines that the viewed portion is not at least the predetermined length, the media guidance application may determine whether the recorded program has a low delete priority setting at step 2008. For example, the media guidance application may access media guidance information associated with the recorded program (e.g., from data structure 200 of FIG. 2) to identify the delete priority setting for that recorded program. The media guidance application may determine that the delete priority setting is low if, for example, a “never delete” or a “preferred recording” flag is not set, if the accessed delete priority setting is not high, or if the delete priority setting is below a predetermined threshold (e.g., if the priority is set to 1 or 2 out of five priority levels). If the media guidance application determines that the delete priority setting for the recording is low, the media guidance application may display a delete prompt at step 2016 for deleting the viewed portion of the recording, and process 2000 ends at step 2018.

If, at step 2008, the media guidance application instead determines that the delete priority level is not low, process 2000 may continue to step 2010. At step 2010, the media guidance application may determine whether the recorded program is of a predetermined type or genre. For example, the media guidance application may determine whether the recording is a documentary, or may determine whether the recording is of a user-specified type (e.g., in yes list 1244 of FIG. 12). If the media guidance application determines that the recording is of a predetermined type, process 2000 may move to step 2016, where the media guidance application displays a delete prompt for the recorded program, and ends at step 2018.

If, at step 2010, the media guidance application instead determines that the recorded program is not of a predetermined type, process 2000 may continue to step 2012. At step 2012, the media guidance application may determine whether the recording is tagged for deletion by other users associated with the recording. For example, the media guidance application may access the user profiles of other users to identify whether other users selected to record the program. For each of the identified users, the media guidance application may determine whether a relevant portion (e.g., viewed portion) of the recording is tagged for deletion. In particular, the media guidance application may determine whether each identified user has expressly tagged the recording for deletion, or the media guidance application may use each identified user's delete priority settings or other preferences to determine whether the relevant portion of the recording is no longer or not of high interest to each user (and therefore effectively tagged for deletion). If the media guidance application determines that the recorded program is tagged for deletion by other users associated with the recorded program, the media guidance application moves to step 2016, where a delete prompt is displayed, then to step 2018 and ends.

If, at step 2012, the media guidance application instead determines that the recording is not tagged for deletion by other users associated with the recorded program, process 2000 continues to step 2014. At step 2014, the media guidance application determines whether the recorded program is of high quality. For example, the media guidance application may access media guidance information for the recorded program (e.g., in data structure 200 of FIG. 2) to determine whether the recorded program is a high-definition or standard-definition recording. The media guidance application may determine that the recorded program is of high quality if the recorded program is a high-definition recording. In this case, the media guidance application may display a delete prompt at step 2016 since high-definition files are by their nature inefficient to store in their entirety. Process 2000 may then continue to step 2018 and end.

If at step 2014, the media guidance application instead determines that the recorded program is of low quality (e.g., standard definition or highly compressed), none of the factors that media guidance application uses to determine whether to display a delete prompt may have been satisfied. Thus, process 2000 may end at step 2018 without displaying a delete prompt to the user.

Process 2000 of FIG. 20 shows one way in which a media guidance application may use a plurality of factors to determine whether a delete prompt should be displayed for a recording when that recording is stopped or paused during playback. In particular, process 2000 shows steps for displaying a delete prompt when only one of the factors are met. Since only one of the factors needs to be met, the media guidance application may display a delete prompt at a relatively high frequency. Thus, the media guidance application may use process 2000 to determine whether to display a delete prompt when the user chooses to have a delete prompt shown at a high frequency (e.g., from frequency of prompt setting 1230 of FIG. 12). The steps of process 2000 may be rearranged, removed, or steps may be added, to create a process that displays a delete prompt at a higher or lower frequency. For example, process 2000 may be modified such that two or more of the factors need to be satisfied in order for a delete prompt to be displayed.

In some embodiments of the present invention, the media guidance application may be customized for different users of the media guidance application. The media guidance application may, for example, provide any type of customized user experience for each user based on preference information or other information stored in a user profile for that user (described above in connection with FIGS. 3 and 4). To provide customized experiences, the media guidance application may determine the identity of the user currently using user equipment 110 (e.g., when a user logs in through a password or through voice recognition, when a user operates a particular interface (e.g., remote or microphone) configured for that user). In some embodiments, in response to identifying the user, the media guidance application may provide personalized guidance screens having targeted advertising or recommendations based on the user's interests.

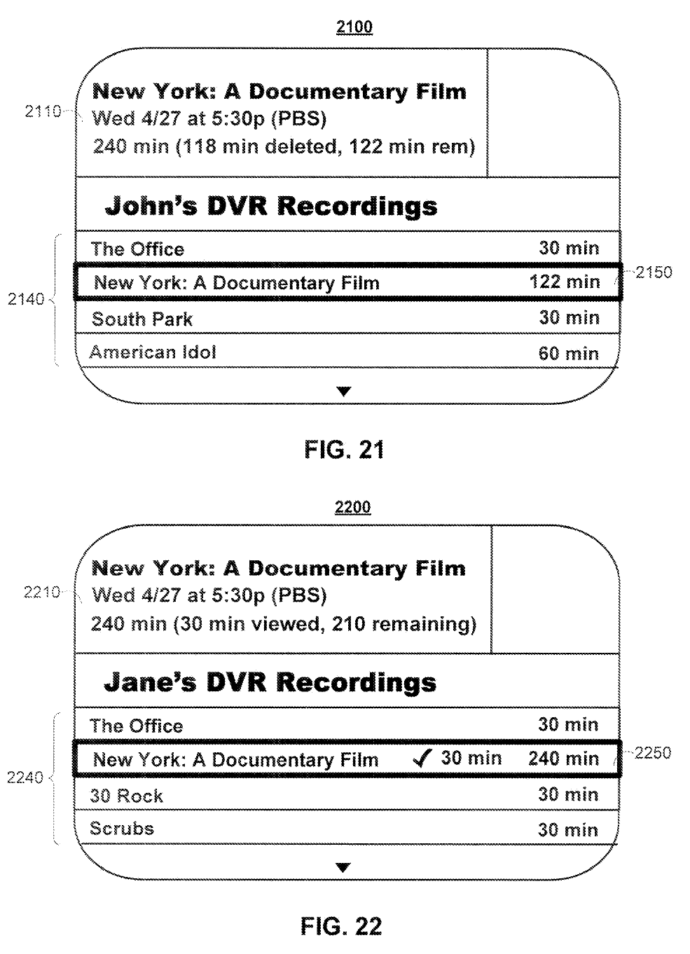

In some embodiments, the media guidance application may maintain or delete portions of recorded programs based on whether the recorded programs are of interest to at least one user. In particular, the media guidance application may maintain recorded programs or portions of the recorded programs that may still be of interest to a user, even if another user has selected to delete that recorded program. These and other user customization features are described below in connection with FIGS. 21-25.

Referring first to FIGS. 21 and 22, illustrative personal recording list display screens 2100 and 2200 are shown. The media guidance application provides display screen 2100 to a first user (e.g., a first user named John) responsive to the first user identifying himself to the media guidance application. The first user may identify himself by logging into the application (e.g., using a password) or using a particular input device (e.g., remote control) or user equipment associated with the first user. The media guidance application provides display screen 2200 to a second user (e.g., a second user named Jane) in response to the second user identifying herself to the media guidance application. Display screens 2100 and 2200 may have similar features and functionalities as the display screens described above in connection with FIGS. 5-9.

Display screen 2100 may include list 2140, which may have listings for recorded programs that are associated with John. For example, the listings may correspond to programs that were recorded automatically for John, or programs that John specifically selected to record. Display screen 2200 of FIG. 22 may include list 2240, which includes listings for programs that were recorded for Jane. The media guidance application may derive lists 2140 and 2240 from recorded programs list 330 (FIG. 3) and recorded programs list 430 (FIG. 4), respectively, stored in recording device 118 (FIG. 1).

In some scenarios, one user of the media guidance application may have selected to delete a portion of a recorded program that another user may still be interested in. The personal recording list display screen for a particular user may reflect the actions taken by the particular user (e.g., program deletions), regardless of whether the media guidance application actually performed the requested actions. For example, John may have viewed 118 minutes of “New York: A Documentary Film” and selected to delete the 118 viewed minutes using any of the techniques described above (e.g., through John's recording list or through a delete prompt overlay). Therefore, John's recording list display screen, display screen 2100, reflects that 118 minutes were deleted from the recorded program and that 122 minutes of the recording are remaining that the user has not viewed. Jane may have only viewed 30 minutes of this program without deleting any portion of the recorded program, as illustrated in FIG. 22. Therefore, even though John has selected to delete 118 minutes of “New York: A Documentary Film,” the media guidance application may maintain the entire recorded program on recording device 118 (FIG. 1) until Jane also decides to delete part or all of this recorded program.

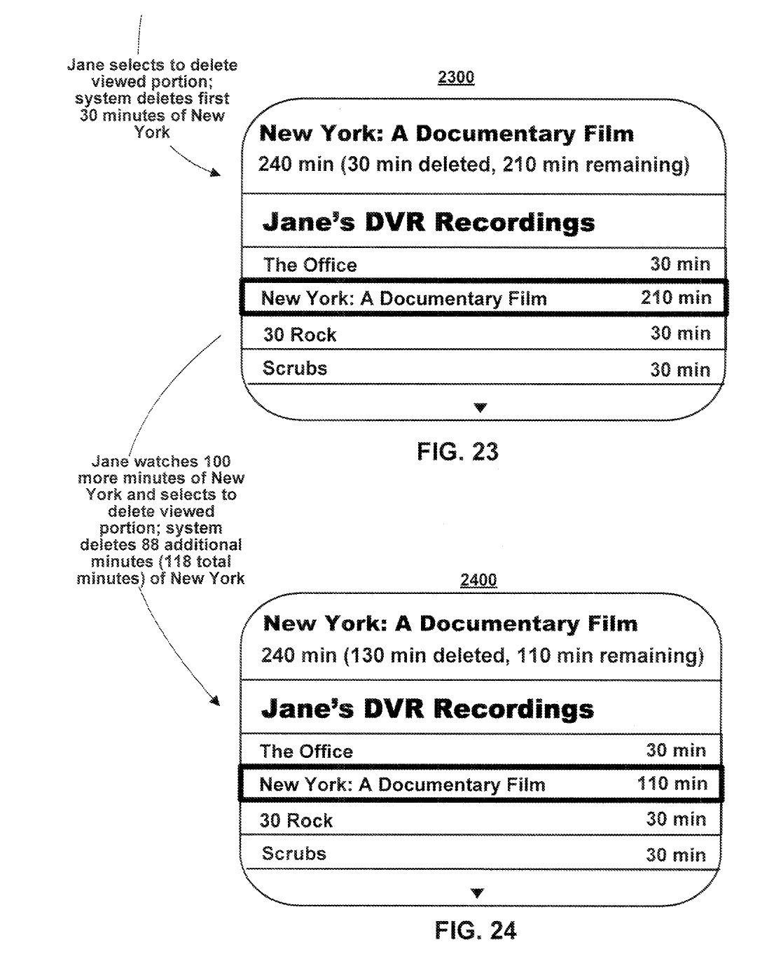

When multiple users are associated with a recorded program, the media guidance application may selectively delete portions of the recording. In particular, the media guidance application may maintain any portion of the recorded program that is of interest to at least one user, and may delete any portion of the recorded program that all of the users associated with the recording have selected to delete. One operating scenario is described in connection with FIGS. 23 and 24, which illustrates how an interactive media guidance application might selectively delete portions of recorded programs. In particular, FIGS. 23 and 24 illustrate how the media guidance application may act in response to a request from Jane (who initially has a recording list display screen as provided in FIG. 22) to delete portions of “New York: A Documentary Film” after John has already selected to delete 118 minutes of this recorded program. For purposes of illustration only, the example is described with the assumption that John and Jane are the only users associated with the program, “New York: A Documentary Film.”

Referring to FIG. 23, the media guidance application may provide personal recording list display screen 2300 to Jane in response to a request from Jane to delete the 30 minutes of “New York: A Documentary Film” that she has already viewed. As shown in display screen 2300, the listing for “New York: A Documentary Film” has been updated from what was shown in FIG. 22 to now show that 210 minutes of the recording is available. Because both Jane and John have selected to delete 30 minutes of this recorded program, the media guidance application may flag those 30 minutes of the recorded program for deletion, and may actually delete those 30 minutes from recording device 118 (FIG. 1).

At this point, Jane may watch another 100 minutes of “New York: A Documentary Film” (for a total of 130 minutes), and may select to delete all viewed portions of this recorded program. In response to receiving the selection, the media guidance application may provide personal recording list display screen 2400 in FIG. 24. Display screen 2400 shows that Jane has now selected to delete 130 minutes of the recorded program and that 110 minutes are still available for viewing. The media guidance application will not delete all 130 viewed minutes of the original recorded program, since John has only selected to delete 118 minutes from the original recorded program. Instead, the media guidance application deletes as much of the recording as possible while still satisfying the retention requirements of John and Jane. In particular, the media guidance application may delete an additional 88 minutes from “New York: A Documentary Film” (for a total of 118 deleted minutes).

The example described above in connection with FIGS. 23 and 24 illustrates a “tagging” technique that may be employed by a media guidance application in a multi-user environment. That is, the media guidance application may make it appear to the first user as if the deletion commands from John and Jane are executed, when in fact some or all of the content is still maintained on the hard drive for the other user. In other embodiments of the present invention, the portion of the program may be seen as marked for deletion by the John and/or Jane but is clearly still available. In some embodiments, the media guidance application may provide at least two different numbers to indicate storage space availability, for example, “free” and “available for recording,” the latter being typically less than or equal to the former.

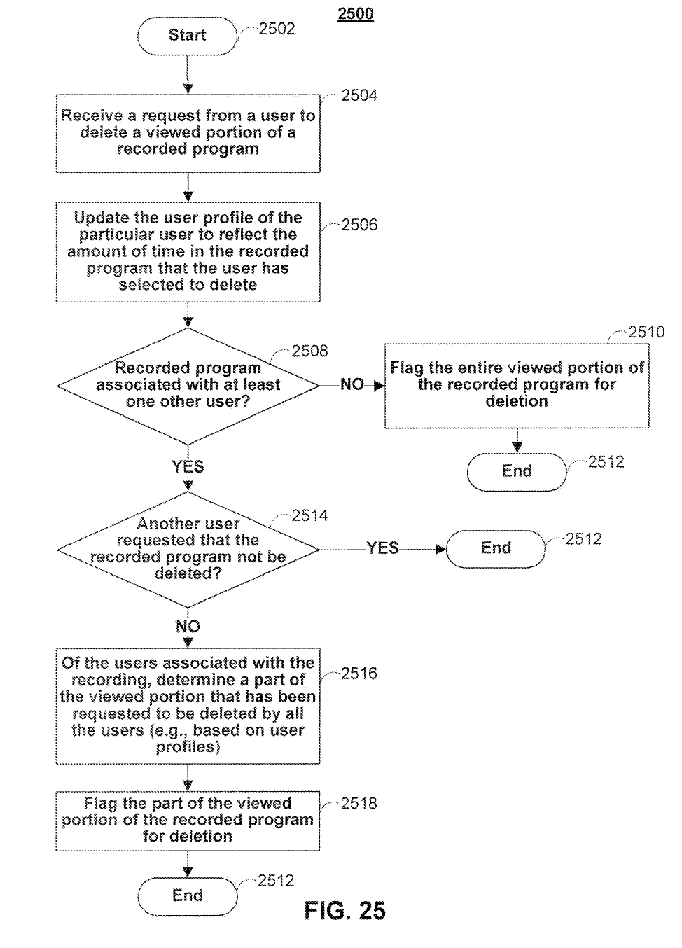

FIG. 25 shows a flowchart of illustrative process 2500 for selectively flagging a portion of a recording for deletion that is associated with multiple users when one of the users selects to delete the portion. The steps of process 2500 may be executed by a media guidance application to provide the functionality described above the illustrative operating scenario of FIGS. 21-24.

Process 2500 may begin at step 2502. At step 2504, the media guidance application may receive a request from a user to delete a viewed portion of a recorded program. For example, step 2504 may involve receiving a user selection from a delete prompt or from a personalized recording list associated with the user. Then, at step 2506, the media guidance application may update the user profile associated with the user to reflect the amount of time in the recorded program that the user has selected to delete. For example, the media guidance application may save a start and end time of the viewed portion (e.g., in data structure 300 or 400 of FIGS. 3 and 4) that the user has selected to delete. Alternatively, the media guidance application may change the start and end times for a viewed portion (e.g., in a viewed portions structure (FIG. 2)) to start and end times for a deleted portion (e.g., in a deleted portions structure (FIG. 2)).

The media guidance application may then determine, at step 2508, whether the recorded program is associated with at least one other user. For example, the media guidance application may search through the user profiles of other users to determine whether the recorded program is also listed in another user's recorded programs list. If the media guidance application determines that the recorded program is not associated with another user, the viewed portion of the recorded program does not need to be retained for viewing by anyone else. Therefore, at step 2510, the media guidance application may flag the entire viewed portion of the recorded program for deletion. Process 2500 may then move to step 2512 and end.

Returning to step 2508 of process 2500, if the media guidance application determines that the recorded program is associated with at least one other user, process 2500 may continue to step 2514. At step 2514, the media guidance application may determine whether any of the users that are also associated with the recorded program have requested that the recording not be deleted. In some embodiments, the media guidance application may search through the user profiles of these other users to determine a delete priority setting for this recorded program, and may make the determination of step 2514 based on the delete priority settings. If, at step 2514, the media guidance application determines that another user has requested that the recorded program not be deleted, process 2500 may move to step 2512 and end.

If, at step 2514, the media guidance application instead determines that another user has not requested that the recorded program be maintained, process 2500 may move to step 2516. At step 2516, the media guidance application may determine a part of the viewed portion of the recorded program that has been selected for deletion by all of the users who are associated with the recorded program. The part of the viewed portion may be as much as the entire viewed portion or may be as little as none of the viewed portion. Then, at step 2518, the media guidance application may flag the part of the viewed portion of the recorded program for deletion, and at step 2512, process 2500 may end.

It should be understood that the steps of process 2500 of FIG. 25 are merely illustrative. Any of the steps may be removed, combined, modified, or any new steps may be added, without departing from the scope of the present invention.

The foregoing describes systems and methods for deleting viewed portions of recorded programs. Those skilled in the art will appreciate that the invention may be practiced by other than the described embodiments, which are presented for the purpose of illustration rather than of limitation.

1. A method for deleting portions of recorded programs, the method comprising:
receiving an instruction from a user to perform an action associated with a recorded program;
determining that a portion of the recorded program has been viewed;
determining the viewed portion of the recorded program; and
flagging a part of the viewed portion of the recorded program for deletion.

2. The method of claim 1, the method further comprising:
deleting the flagged part of the viewed portion of the recorded program.

3. The method of claim 1, wherein flagging the part of the viewed portion comprises:
indicating to the user that the part of the viewed portion has been deleted.

4. The method of claim 3, wherein the part of the viewed portion is indicated to the user as having been deleted before the part of the viewed portion is actually deleted.

5. The method of claim 1, wherein flagging the part of the viewed portion comprises indicating to the user that the part of the viewed portion will be deleted.

6. The method of claim 1, wherein the flagging is performed without indicating to the user that the part of the viewed portion has been or will be deleted.

7. The method of claim 1, wherein the instruction is a general preference setting related to deleting viewed portions of programs, and flagging the part of the viewed portion of the program for deletion is a function of a dialog with the user.

8. The method of claim 1, wherein the flagged part of the viewed portion is the entire viewed portion.

9. The method of claim 1, wherein the recorded program is associated with an other user, and the flagged part of the viewed portion is the lesser of the viewed portion of the recorded program and a portion of the recorded program that has been viewed by the other user.

10. The method of claim 1, the method further comprising:
displaying an indication of a length of the flagged part of the viewed portion.

11. The method of claim 1, the method further comprising:
displaying an indication of the percentage of disk space that is used by the flagged part of the viewed portion.

12. The method of claim 1, wherein receiving the instruction from the user comprises receiving a selection from the user of the recorded program.

13. The method of claim 12, wherein:
receiving the instruction from the user further comprises receiving a selection from the user of at least one other recorded program, the method further comprising:
determining a portion of the other recorded program that has been viewed; and
flagging a part of the viewed portion of the at least one other recorded program for deletion.

14. The method of claim 13, the method further comprising:
deleting the flagged parts of both the viewed portion of the recorded program and the viewed portion of the at least one other recorded program.

15. The method of claim 1, wherein the part of the viewed portion that is flagged is a function of whether the recorded program is associated with another user, the method further comprising:
deleting the flagged part of the recorded program when it is not associated with another user.

16. The method of claim 1, wherein flagging the part of the viewed portion of the recorded program comprises:
keeping track of an amount of the recorded program that the user has decided to delete.

17. The method of claim 1, wherein flagging the part of the viewed portion of the recorded program for deletion comprises:
updating system storage usage statistics.

18. The method of claim 1, the method further comprising:
playing the recorded program, wherein
receiving an instruction from the user to perform an action associated with the recorded program comprises receiving a stop or pause command from the user at a current viewing position in the recorded program.

19. The method of claim 1, wherein the flagging is a function of whether an amount of storage space remaining in a storage device for the recorded program is below a predetermined level.

20. The method of claim 1, wherein the flagging is a function of the number of programs stored on a storage device for the recorded program.

21. The method of claim 1, wherein the flagging is a function of whether the part of the viewed portion of the recorded program is at least a predetermined length.

22. The method of claim 1, wherein the flagging is a function of whether the recorded program is at least a predetermined genre.

23. The method of claim 1, wherein the flagging is a function of a delete priority setting associated with the recorded program.

24. The method of claim 1, wherein the flagging is a function of a recording quality associated with the recorded program.

25. The method of claim 1, the method further comprising:
selecting an ending time of the part of the viewed portion based on a current viewing position of the recorded program.

26. The method of claim 25, wherein the ending time is a predetermined amount of time before the current viewing position.

27. The method of claim 25, wherein the ending time corresponds to an end of a most recent scene, chapter, or commercial break prior to the current viewing position.

28. The method of claim 1, wherein determining the viewed portion is a function of fast-forward or rewind commands received from the user during playback of the recorded program.

29. The method of claim 1, wherein determining the viewed portion comprises:
including in the viewed portion of the recorded program portions of the recorded program corresponding to commercials that the user fast forwarded through during playback.

30. The method of claim 1, further comprising:
performing an action associated with an other program, wherein the part of the viewed portion of the recorded program is flagged as a result of the action associated with the other program.

31. A system for deleting portions of recorded programs, the system comprising:
a display device;
a user input device;
a storage device for storing recorded programs; and
an interactive application implemented at least partially on user equipment and configured to:
receive, from the user input device, an instruction from a user to perform an action associated with a recorded program;
determine that a portion of a recorded program has been viewed;
determine the viewed portion of the recorded program; and
flag a part of the viewed portion of the recorded program for deletion.

32. The system of claim 31, wherein the interactive application is further configured to:
delete the flagged part of the viewed portion of the recorded program from the storage device.

33. The system of claim 31, wherein the interactive application is further configured to:
indicate to the user on the display device that the part of the viewed portion has been deleted.

34. The system of claim 33, wherein the part of the viewed portion is indicated to the user as having been deleted before the part of the viewed portion is actually deleted.

35. The system of claim 31, wherein the interactive application is further configured to:
indicate to the user on the display device that the part of the viewed portion will be deleted.

36. The system of claim 31, wherein the part of the viewed portion is flagged without indicating to the user that the part of the viewed portion has been or will be deleted.

37. The system of claim 31, wherein the instruction is a general preference setting related to deleting viewed portions of programs, and wherein the interactive application flags the part of the viewed portion based on a dialog with the user.

38. The system of claim 31, wherein the flagged part of the viewed portion is the entire viewed portion.

39. The system of claim 31, wherein the recorded program is associated with an other user, and the flagged part of the viewed portion is the lesser of the viewed portion of the recorded program and a portion of the recorded program that has been viewed by the other user.

40. The system of claim 31, wherein the interactive application is further configured to:
display an indication on the display device of a length of the flagged part of the viewed portion.

41. The system of claim 31, wherein the interactive application is further configured to:
display an indication on the display device of the percentage of disk space that is used by the flagged part of the viewed portion.

42. The system of claim 31, wherein the instruction received from the user comprises a selection from the user of the recorded program.

43. The system of claim 42, wherein the instruction received from the user further comprises a selection from the user of at least one other recorded program, and wherein the interactive application is further configured to:
determine a portion of the other recorded program that has been viewed; and
flag a part of the viewed portion of the at least one other recorded program for deletion.

44. The system of claim 43, wherein the interactive application is further configured to:
delete the flagged parts of both the viewed portion of the recorded program and the viewed portion of the at least one other recorded program.

45. The system of claim 31, wherein the part of the viewed portion that is flagged is a function of whether the recorded program is associated with another user, and wherein the interactive application is further configured to:
delete the flagged part of the recorded program when it is not associated with another user.

46. The system of claim 31, wherein the interactive application is further configured to:
keep track of an amount of the recorded program that the user has decided to delete.

47. The system of claim 31, wherein the interactive application is further configured to:
update system storage usage statistics to reflect that the part of the viewed portion of the recorded program has been flagged for deletion.

48. The system of claim 31, wherein the interactive application is further configured to:
play the recorded program, wherein
the instruction received from the user comprises a stop or pause command received from the user at a current viewing position in the recorded program.

49. The system of claim 31, wherein the interactive application is configured to flag the part of the viewed portion based on whether an amount of storage space remaining in a storage device for the recorded program is below a predetermined level.

50. The system of claim 31, wherein the interactive application is configured to flag the part of the viewed portion based on the number of programs stored on a storage device for the recorded program.

51. The system of claim 31, wherein the interactive application is configured to flag the part of the viewed portion based on whether the part of the portion of the recorded program is at least a predetermined length.

52. The system of claim 31, wherein the interactive application is configured to flag the part of the viewed portion based on whether the recorded program is at least a predetermined genre.

53. The system of claim 31, wherein the interactive application is configured to flag the part of the viewed portion based on a delete priority setting associated with the recorded program.

54. The system of claim 31, wherein the interactive application is configured to flag the part of the viewed portion based on a recording quality associated with the recorded program.

55. The system of claim 31, wherein the interactive application is further configured to:
select an ending time of the part of the viewed portion based on a current viewing position of the recorded program.

56. The system of claim 55, wherein the ending time is a predetermined amount of time before the current viewing position.

57. The system of claim 55, wherein the ending time corresponds to an end of a most recent scene, chapter, or commercial break prior to the current viewing position.

58. The system of claim 31, wherein interactive application is further configured to:
determine the viewed portion based on fast-forward or rewind commands received from the user during playback of the recorded program.

59. The system of claim 31, wherein the interactive application is further configured to:
include in the viewed portion of the recorded program portions of the recorded program corresponding to commercials that the user fast forwarded through during playback.

60. The system of claim 31, wherein the interactive application is further configured to:
perform an action associated with an other program, wherein the part of the viewed portion of the recorded program is flagged as a result of the action associated with the other program.

61-90. (canceled)
